(19) United States
(12) Patent Application Publication
(10) Pub. No.: US 2015/0112490 A1
(43) Pub. Date: Apr. 23, 2015

(54) METHODS AND SYSTEMS TO ALTER THE PERMEABILITY OF A BIOLOGICAL OBJECT

(71) Applicant: TOKITAE LLC, Bellevue, WA (US)

(72) Inventors: Ryan Calderon, Seattle, WA (US); Cary Richard Champlin, Issaquah, WA (US); David Gasperino, Lake Forest Park, WA (US); Emma Rae Mullen, Seattle, WA (US); Kevin Paul Floods Nichols, Seattle, WA (US); David Keith Piech, Seattle, WA (US)

(73) Assignee: TOKITAE LLC, Bellevue, WA (US)

(21) Appl. No.: 14/061,656

(22) Filed: Oct. 23, 2013

(51) Int. Cl. G05D 7/06

(52) U.S. Cl. CPC G05D 7/0682
USPC 700/282

(57) ABSTRACT

The present disclosure relates to methods and systems that may be used to alter the permeability of a biological object. In some embodiments, the methods and systems may be used to alter the permeability of a non-human embryo. In some embodiments, the methods and systems may be used to alter the permeability of an insect embryo. In some embodiments, the methods and systems may be used to alter the permeability of a mosquito embryo.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

Priority Applications:

None.

Related Applications:

None.

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one aspect, a system includes, but is not limited to, circuitry configured to control transport of at least one biological object through at least one flow channel in at least one carrier fluid, circuitry configured to dynamically determine a position of the at least one biological object that is being transported through the at least one flow channel, and circuitry configured to direct focused energy to cause at least one cavitation induced perforation in the at least one biological object in response to the circuitry configured to dynamically determine the position of the at least one biological object in the at least one flow channel. In addition to the foregoing, other system aspects are described in the claims, drawings, and text forming a part of the present disclosure.

In one aspect, a system includes, but is not limited to, means for transporting at least one biological object through at least one flow channel in at least one carrier fluid, means for dynamically determining a position of the at least one biological object that is being transported through the at least one flow channel, and means for directing focused energy to cause at least one cavitation induced perforation in the at least one biological object in response to dynamically determining the position of the at least one biological object in the at least one flow channel. In addition to the foregoing, other system aspects are described in the claims, drawings, and text forming a part of the present disclosure.

In one aspect, a system includes, but is not limited to, a computer program product including at least one non-transitory computer readable media including at least: one or more instructions to control transport of at least one biological object through at least one flow channel in at least one carrier fluid, one or more instructions to dynamically determine a position of the at least one biological object that is being transported through the at least one flow channel, and one or more instructions to direct focused energy to cause at least one cavitation induced perforation in the at least one biological object in response to dynamically determining the position of the at least one biological object in the at least one flow channel. In addition to the foregoing, other system aspects are described in the claims, drawings, and text forming a part of the present disclosure.

In one aspect, a method includes, but is not limited to, transporting at least one biological object through at least one flow channel in at least one carrier fluid, dynamically determining a position of the at least one biological object that is being transported through the at least one flow channel, and directing focused energy to cause at least one cavitation induced perforation in the at least one biological object in response to dynamically determining the position of the at least one biological object in the at least one flow channel. In addition to the foregoing, other method aspects are described in the claims, drawings, and text forming a part of the present disclosure.

In one aspect, a method includes, but is not limited to, transporting at least one mosquito embryo through at least one flow channel in at least one carrier fluid, dynamically determining a position of the at least one mosquito embryo that is being transported through the at least one flow channel, and directing laser light to cause at least one cavitation induced perforation in the at least one mosquito embryo in response to dynamically determining the position of the at least one mosquito embryo in the at least one flow channel. In addition to the foregoing, other method aspects are described in the claims, drawings, and text forming a part of the present disclosure.

In one or more various aspects, means include but are not limited to circuitry and/or programming for effecting the herein referenced functional aspects; the circuitry and/or programming can be virtually any combination of hardware, software, and/or firmware configured to effect the herein referenced functional aspects depending upon the design choices of the system designer. In addition to the foregoing, other system aspects means are described in the claims, drawings, and/or text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein referenced method aspects depending upon the design choices of the system designer. In addition to the foregoing, other system aspects are described in the claims, drawings, and/or text forming a part of the present application.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 illustrates an example system 100 in which embodiments may be implemented.

FIG. 2 illustrates example components of system 100 in which embodiments may be implemented.

FIG. 3 illustrates example components of system 100 in which embodiments may be implemented.

FIG. 4 illustrates example components of system 100 in which embodiments may be implemented.

FIG. 5 illustrates a top view of an example system 500 in which embodiments may be implemented.

FIG. 6 illustrates a top view of an example system 600 in which embodiments may be implemented.

FIG. 7 illustrates a top view of example system 700 in which embodiments may be implemented.

FIG. 8 illustrates a top view of example system 800 in which embodiments may be implemented.

FIG. 9 illustrates a top view of example system 900 in which embodiments may be implemented.

FIG. 10 illustrates a side view of example system 1000 in which embodiments may be implemented.

FIG. 11 illustrates a side view of example system 1100 in which embodiments may be implemented.

FIG. 12 illustrates a side view of example system 1200 in which embodiments may be implemented.

FIG. 13 illustrates an example operational flow 1300 in which embodiments may be implemented.

FIG. 14 illustrates an example operational flow 1400 in which embodiments may be implemented.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

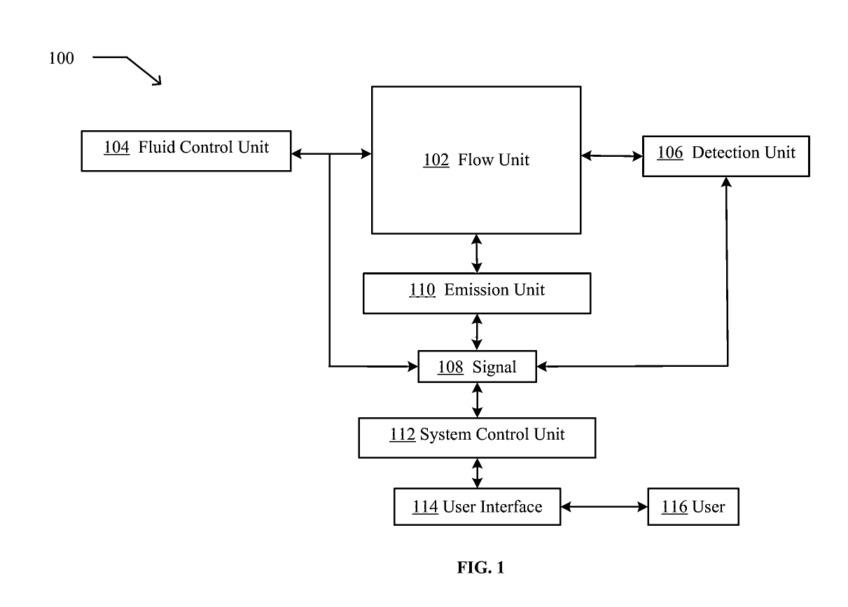

FIG. 1 illustrates an example system 100 in which embodiments may be implemented. The system 100 may include one or more flow units 102. The system 100 may include one or more fluid control units 104. The system 100 may include one or more detection units 106. The system 100 may include one or more signals 108. The system 100 may include one or more emission units 110. The system 100 may include one or more system control units 112. The system 100 may include one or more user interfaces 114. The system 100 may include one or more users 116.

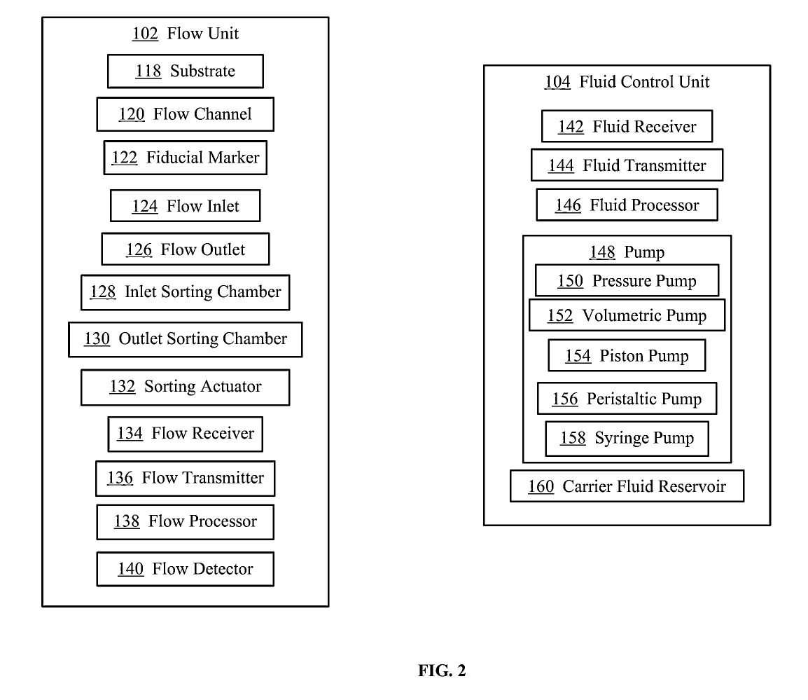

FIG. 2 illustrates example embodiments of components of system 100. The illustrated components include a flow unit 102 and a fluid control unit 104.

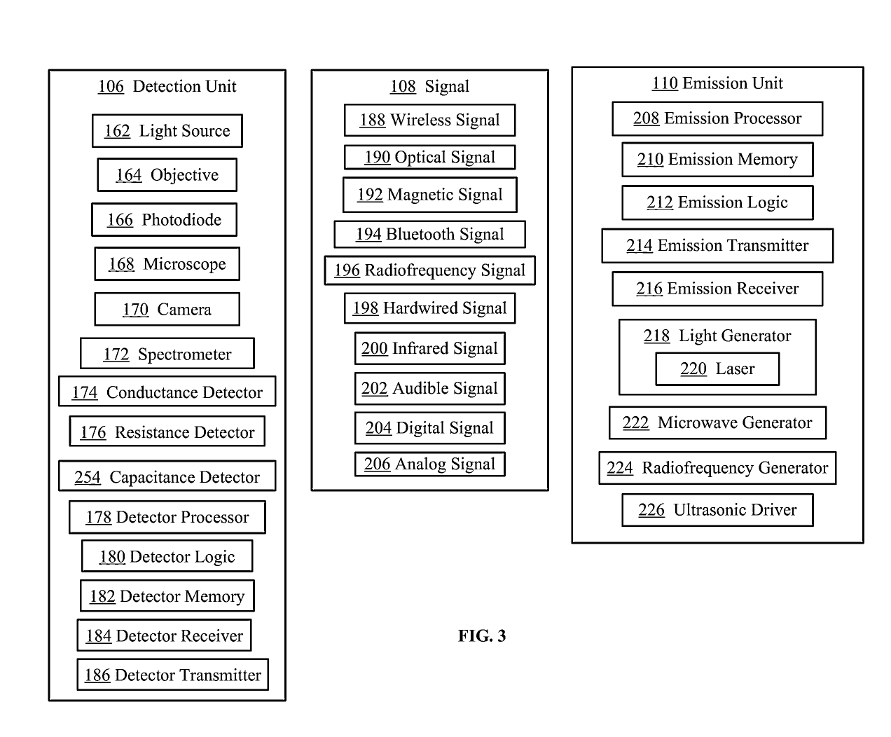

FIG. 3 illustrates example embodiments of components of system 100. The illustrated components include a detection unit 106, a signal 108, and an emission unit 110.

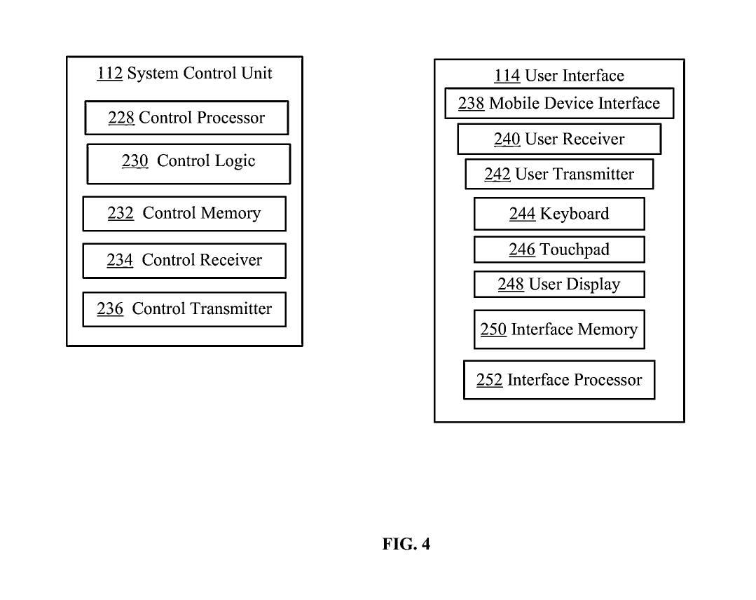

FIG. 4 illustrates a system control unit 112 and a user interface 114.

### Biological Object

In some embodiments, numerous types of biological objects may be used in association with system 100. Examples of such biological objects include, but are not limited to, bacteria, cells, human cells, non-human cells, plant cells, eggs, avian eggs, non-human embryos, non-human mammalian embryos, insect embryos, mosquito embryos, fish embryos, and the like.

### Flow Unit

In some embodiments, system 100 may include one or more flow units 102. In some embodiments, a flow unit 102 may include one or more substrates 118. In some embodiments, a flow unit 102 may include one or more flow channels 120. In some embodiments, a flow unit 102 may include one or more substrates 118 that include one or more flow channels 120. In some embodiments, a flow unit 102 may include one or more substrates 118 that include one or more fiducial markers 122. In some embodiments, a flow unit 102 may include one or more flow inlets 124. In some embodiments, a flow unit 102 may include one or more flow inlets 124 that are fluidly coupled with one or more flow channels 120. In some embodiments, a flow unit 102 may include one or more flow outlets 126. In some embodiments, a flow unit 102 may include one or more flow outlets 126 that are fluidly coupled with one or more flow channels 120. In some embodiments, a flow unit 102 may include one or more flow inlets 124 and one or more flow outlets 126. In some embodiments, a flow unit 102 may include one or more flow inlets 124 and one or more flow outlets 126 that are fluidly coupled with one or more flow channels 120. In some embodiments, a flow unit 102 may include one or more inlet sorting chambers 128. In some embodiments, a flow unit 102 may include one or more inlet sorting chambers 128 that are fluidly coupled with one or more flow channels 120. In some embodiments, a flow unit 102 may include one or more outlet sorting chambers 130. In some embodiments, a flow unit 102 may include one or more outlet sorting chambers 130 that are fluidly coupled with one or more flow channels 120. In some embodiments, a flow unit 102 may include one or more inlet sorting chambers 128 and one or more outlet sorting chambers 130. In some embodiments, a flow unit 102 may include one or more inlet sorting chambers 128 and one or more outlet sorting chambers 130 that are fluidly coupled with one or more flow channels 120. In some embodiments, a flow unit 102 may include one or more flow detectors 140 (see e.g., Lien and Vollmer, Microfluidic flow rate detection based on integrated optical fiber cantilever, Lab Chip, 7:1352-1356 (2007)).

A substrate may be fabricated from numerous types of material and combinations of materials. Examples of such materials include, but are not limited to, glass, plastic, ceramics, metals, polymeric materials, photoresist (e.g., SU-8 2005, 2015, 2025, 2075) (Microchem, Newton, Mass.), poly(dimethylsiloxane) (PDMS) (Dow Corning, Midland, Mich.), quartz (SPI Supplies, West Chester, Pa.), and the like. In some embodiments, a substrate may include one layer of material. In some embodiments, a substrate may include two layers of material. In some embodiments, a substrate may include multiple layers of material. For example, in some embodiments, a substrate 118 may be fabricated from three layers of material that include a top layer of quartz, a middle layer of photoresist, and a bottom layer of quartz. In some embodiments, a substrate 118 may be fabricated from three layers of material that include a top layer of quartz, a middle layer of photoresist, and a bottom layer of poly(dimethylsiloxane). Numerous methods may be used to fabricate a substrate 118. Many such fabrication methods are used in the computer industry. Examples of such methods include, but are not limited to, photolithography, spin coating, lamination techniques, printing, stamping, laser etching, molding, and the like (see e.g., Ou et al., Fabrication of a hybrid PDMS/SU-8/quartz microfluidic chip for enhancing UV absorption whole-channel imaging detection sensitivity and application for isoelectric focusing of proteins, Lab Chip, 9(13):1926-1932 (2009)).

In some embodiments, a substrate 118 may include one or more flow channels 120. Flow channels 120 may be configured in numerous ways. For example, in some embodiments, a flow channel 120 may be configured as a straight flow channel 120. In some embodiments, a flow channel 120 may be configured as a branched flow channel 120. In some embodiments, a flow channel 120 may be configured as a curved flow channel 120. In some embodiments, a flow channel 120 may be fluidly coupled to one or more flow inlets 124. In some embodiments, a flow channel 120 may be fluidly coupled to one or more flow outlets 126. In some embodiments, a flow channel 120 may be fluidly coupled to one or more flow inlets 124 and one or more flow outlets 126. In some embodiments, a flow channel 120 may be fluidly coupled to one or more inlet sorting chambers 128. In some embodiments, a flow channel 120 may be fluidly coupled to one or more outlet sorting chambers 130. In some embodiments, a flow channel 120 may be fluidly coupled to one or more inlet sorting chambers 128 and one or more outlet sorting chambers 130. In some embodiments, flow channels 120 may be fabricated having numerous dimensions. In some embodiments, flow channels 120 may be fabricated that have numerous widths, depths, lengths, and combinations thereof. For example, in some embodiments, a flow channel 120 may be fabricated that has a width that is between about 10 centimeters and about 1 centimeter. In some embodiments, a flow channel 120 may be fabricated that has a width that is between about 5 centimeters and about 1 centimeter. In some embodiments, a flow channel 120 may be fabricated that has a width that is between about 1000 millimeters and about 10 millimeters. In some embodiments, a flow channel 120 may be fabricated that has a width that is between about 10 millimeters and about 1 millimeter. In some embodiments, a flow channel 120 may be fabricated that has a width that is between about 1 millimeter and about 0.1 millimeter. In some embodiments, a flow channel 120 may be fabricated that has a width that is between about 0.4 millimeter and about 0.2 millimeter. In some embodiments, a flow channel 120 may be fabricated that has a width that is about 0.3 millimeter. In some embodiments, a flow channel 120 may be fabricated that has a width that is between about 200 micrometers and about 50 micrometers. In some embodiments, a flow channel 120 may be fabricated that has a width that is between about 50 micrometers and about 5 micrometers. In some embodiments, a flow channel 120 may be fabricated that has a depth that is between about 10 centimeters and about 1 centimeter. In some embodiments, a flow channel 120 may be fabricated that has a depth that is between about 5 centimeters and about 1 centimeter. In some embodiments, a flow channel 120 may be fabricated that has a depth that is between about 1000 millimeters and about 10 millimeters. In some embodiments, a flow channel 120 may be fabricated that has a depth that is between about 10 millimeters and about 1 millimeter. In some embodiments, a flow channel 120 may be fabricated that has a depth that is between about 1 millimeter and about 0.1 millimeter. In some embodiments, a flow channel 120 may be fabricated that has a depth that is between about 0.4 millimeter and about 0.2 millimeter. In some embodiments, a flow channel 120 may be fabricated that has a depth that is about 0.3 millimeter. In some embodiments, a flow channel 120 may be fabricated that has a depth that is between about 200 micrometers and about 50 micrometers. In some embodiments, a flow channel 120 may be fabricated that has a depth that is between about 50 micrometers and about 5 micrometers. In some embodiments, a flow channel 120 may be fabricated that has a width and a depth that are between about 10 centimeters and about 1 centimeter. In some embodiments, a flow channel 120 may be fabricated that has a width and a depth that are between about 5 centimeters and about 1 centimeter. In some embodiments, a flow channel 120 may be fabricated that has a width and a depth that are between about 1000 millimeters and about 10 millimeters. In some embodiments, a flow channel 120 may be fabricated that has a width and a depth that are between about 10 millimeters and about 1 millimeter. In some embodiments, a flow channel 120 may be fabricated that has a width and a depth that are between about 1 millimeter and about 0.1 millimeter. In some embodiments, a flow channel 120 may be fabricated that has a width and a depth that are between about 0.4 millimeter and about 0.2 millimeter. In some embodiments, a flow channel 120 may be fabricated that has a width and a depth that are about 0.3 millimeter. In some embodiments, a flow channel 120 may be fabricated that has a width and a depth that are between about 200 micrometers and about 50 micrometers. In some embodiments, a flow channel 120 may be fabricated that has a width and a depth that are between about 50 micrometers and about 5 micrometers. In some embodiments, a flow channel 120 may be fabricated that has a length that is between about 1 meter and about 100 centimeters. In some embodiments, a flow channel 120 may be fabricated that has a length that is between about 100 centimeters and about 1 centimeter. In some embodiments, a flow channel 120 may be fabricated that has a length that is between about 50 centimeters and about 1 centimeter. In some embodiments, a flow channel 120 may be fabricated that has a length that is between about 20 centimeters and about 1 centimeter. In some embodiments, a flow channel 120 may be fabricated that has a length that is between about 10 centimeters and about 1 centimeter. In some embodiments, a flow channel 120 may be fabricated that has a length that is between about 5 centimeters and about 1 centimeter. In some embodiments, a flow channel 120 may be fabricated that has a length that is about 1 centimeter.

Numerous types of carrier fluids may be used within a flow channel 120. Examples of such carrier fluids include, but are not limited to, hydrophilic carrier fluids, hydrophobic carrier fluids, aqueous carrier fluids, buffers, solvents, and the like. In some embodiments, one or more articles may be included in a carrier fluid. In some embodiments, an article may enter into a biological object through a cavitation induced perforation in the biological object. Examples of articles include, but are not limited to, nucleic acid constructs, peptides, antibodies, tags, bacteria, and the like (see e.g., Catteruccia et al., Toward Anopheles transformation: Minos element in anopheline cells and embryos, Proc. Natl. Acad. Sci. USA, 97(5): 2157-2162 (2000) and Bian et al., Wolbachia invades Anopheles stephensi populations and induces refractoriness to Plasmodium infection, Science, 340(6133): 748-51 (2013)).

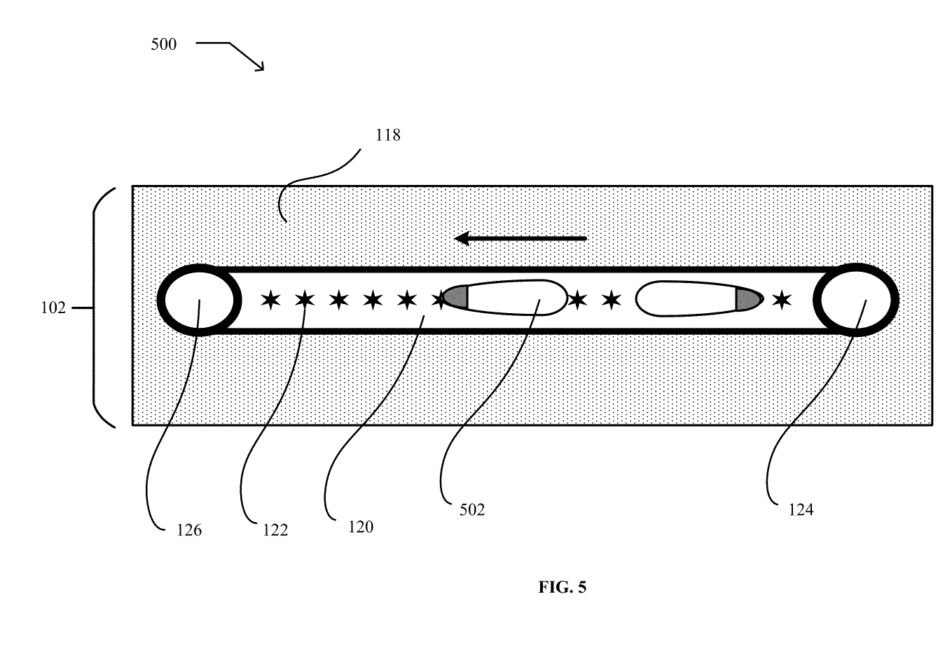

In some embodiments, a substrate 118 and flow channel 120 may be configured to provide for transport a specific biological object in a carrier fluid. For example, in some embodiments, a substrate 118 and flow channel 120 may be configured to provide for transport of a chicken egg through a flow channel 120 in a carrier fluid. Accordingly, in some embodiments, a substrate 118 may be fabricated that includes one or more flow channels 120 that have a width and depth that allow a chicken egg to be transported in a carrier fluid. In some embodiments, a flow channel 120 may be configured to position a biological object while it is being transported through a flow channel 120 in a carrier fluid. For example, in some embodiments, a flow channel 120 may be configured to have a width and depth that are smaller than the length of a biological object but that are greater than the cross-sectional diameter of the biological object. Accordingly, in some embodiments, a flow channel 120 may be configured to position a biological object having an ovoid shape while it is being transported through the flow channel 120 with the length of the biological object being oriented in accordance with the direction of carrier fluid flow. In some embodiments, a flow channel 120 may be fabricated that will position a mosquito embryo while it is being transported through the flow channel 120 in a carrier fluid. In some embodiments, a mosquito embryo may have an ovoid shape with the anterior portion of the embryo being positioned at one end of the lengthwise axis of the ovoid shape and the posterior portion of the mosquito embryo being positioned at the opposite end of the lengthwise axis of the ovoid shaped mosquito embryo. In some embodiments, the anterior portion of a mosquito embryo may have a greater cross-sectional diameter than the posterior portion of the mosquito embryo (see for example, FIG. 5). In addition, in some embodiments, the posterior portion of a mosquito embryo may be darker in color than the anterior portion of the mosquito embryo. Accordingly, in some embodiments, a flow channel 120 may be fabricated that has a width and depth that are smaller than the length of a mosquito embryo but that are greater than the cross-sectional diameter of the mosquito embryo. Such a flow channel 120 may position a mosquito embryo being transported through a flow channel 120 so that the length of the mosquito embryo is oriented in accordance with the direction of fluid flow (see for example, FIG. 5).

A flow channel 120 may be fabricated through use of numerous techniques. For example, in some embodiments, a substrate 118 that includes a flow channel 120 may be constructed by spin coating a quartz layer with SU-8 photoresist, creating the flow channel 120 through use of photolithography, and then plasma bonding a layer of PDMS onto the SU-8 photoresist. In some embodiments, one or more flow channels 120 may be fabricated through use of laser etching to create the one or more flow channels 120 in a substrate 118. In some embodiments, one or more flow channels 120 may be fabricated through use of a casting process to create a substrate 118 that includes one or more flow channels 120. In some embodiments, one or more flow channels 120 may be fabricated through use of machining to create the one or more flow channels 120 in a substrate 118.

In some embodiments, a flow unit 102 may be associated with one or more fiducial markers 122. For example, in some embodiments, a flow unit 102 may include a substrate 118 that includes one or more fiducial markers 122 that indicate one or more positions along the length of one or more flow channels 120 in the substrate 118. Accordingly, in some embodiments, one or more fiducial markers 122 that are associated with a flow channel 120 may be used to determine a position and/or orientation of a biological object that is being transported through the flow channel 120 in a carrier fluid. For example, in some embodiments, a series of fiducial markers 122 may be associated with a flow channel 120 that are spaced at known positions along the path of the flow channel 120. Accordingly, in some embodiments, the positions of one or more biological objects that are being transported through a flow channel 120 may be determined by detecting their position relative to the position of one or more fiducial markers 122 that have a known position in the flow channel 120 (see for example, FIG. 5).

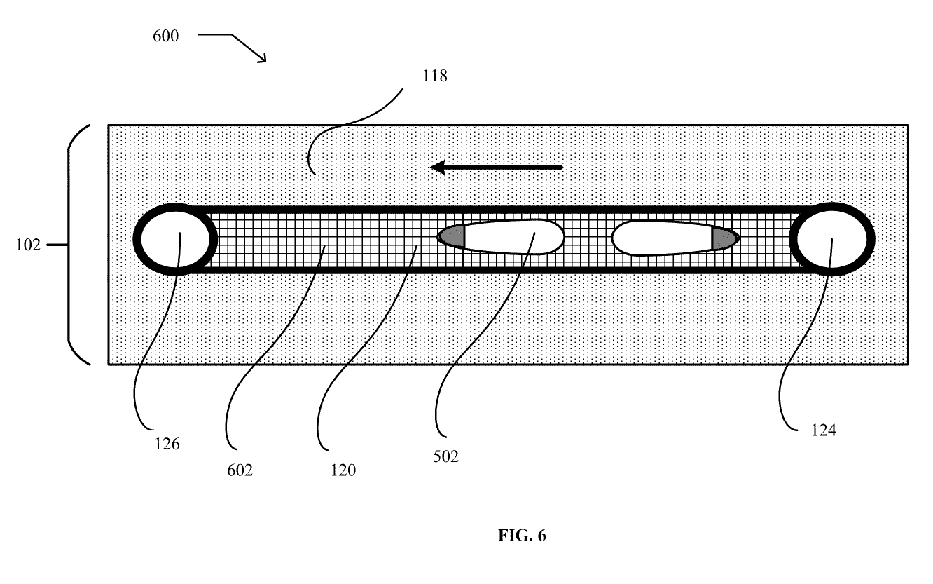

In some embodiments, a flow channel 120 may be associated with a calibrated grid pattern that may be used to determine the position and/or orientation of a biological object that is being transported through the flow channel 120. For example, in some embodiments, the position and anterior-posterior orientation of a mosquito embryo that is being transported through a flow channel 120 may be determined through use of a calibrated grid pattern that is associated with the flow channel 120 (see for example, FIG. 6). In such an embodiment, the position of the mosquito embryo may be determined by comparing the detected position of the mosquito embryo to a calibrated grid pattern that indicates known positions along the length of the flow channel 120. In such an embodiment, the anterior-posterior orientation of the mosquito embryo in the flow channel may be determined by comparing widths that are detected along the length of the mosquito embryo to a calibrated grid pattern that indicates known positions across the width of the flow channel 120. Accordingly, in some embodiments, the anterior-posterior orientation of the mosquito embryo can be determined by detecting the width of the mosquito embryo at each of the poles of the mosquito embryo with the pole having the greater width being the anterior pole and the pole having the smaller width being the posterior pole of the mosquito embryo (see for example, FIG. 6).

In some embodiments, a flow unit 102 may include one or more flow inlets 124. In some embodiments, one or more flow inlets 124 may be fluidly coupled to one or more flow channels 120. Flow inlets 124 may be configured in numerous ways. For example, in some embodiments, a flow inlet 124 may be operably coupled to a nanoport connector (see e.g., Schafer et al., Microfluidic cell counter with embedded optical fibers fabricated by femtosecond laser ablation and anionic bonding, Optics Express, 17(8): 6068-6073 (2009)). In some embodiments, a flow inlet 124 may be operably coupled to a leur lock connector. In some embodiments, a flow inlet 124 may be operably coupled to a friction fitting connector.

Flow inlets 124 may be fabricated through use of numerous techniques. For example, in some embodiments, a flow inlet 124 may fabricated through use of a hole punch. In some embodiments, a flow inlet 124 may fabricated through use of laser ablation. In some embodiments, a flow inlet 124 may fabricated through use of a drill.

In some embodiments, a flow unit 102 may include one or more flow outlets 126. In some embodiments, one or more flow outlets 126 may be fluidly coupled to one or more flow channels 120. Flow outlets 126 may be configured in numerous ways. For example, in some embodiments, a flow outlet 126 may be operably coupled to a nanoport connector (see e.g., Schafer et al., Microfluidic cell counter with embedded optical fibers fabricated by femtosecond laser ablation and anionic bonding, Optics Express, 17(8): 6068-6073 (2009)). In some embodiments, a flow outlet 126 may be operably coupled to a leur lock connector. In some embodiments, a flow outlet 126 may be operably coupled to a friction fitting connector.

Flow outlets 126 may be fabricated through use of numerous techniques. For example, in some embodiments, a flow outlet 126 may fabricated through use of a hole punch. In some embodiments, a flow outlet 126 may fabricated through use of laser ablation. In some embodiments, a flow outlet 126 may fabricated through use of a drill.

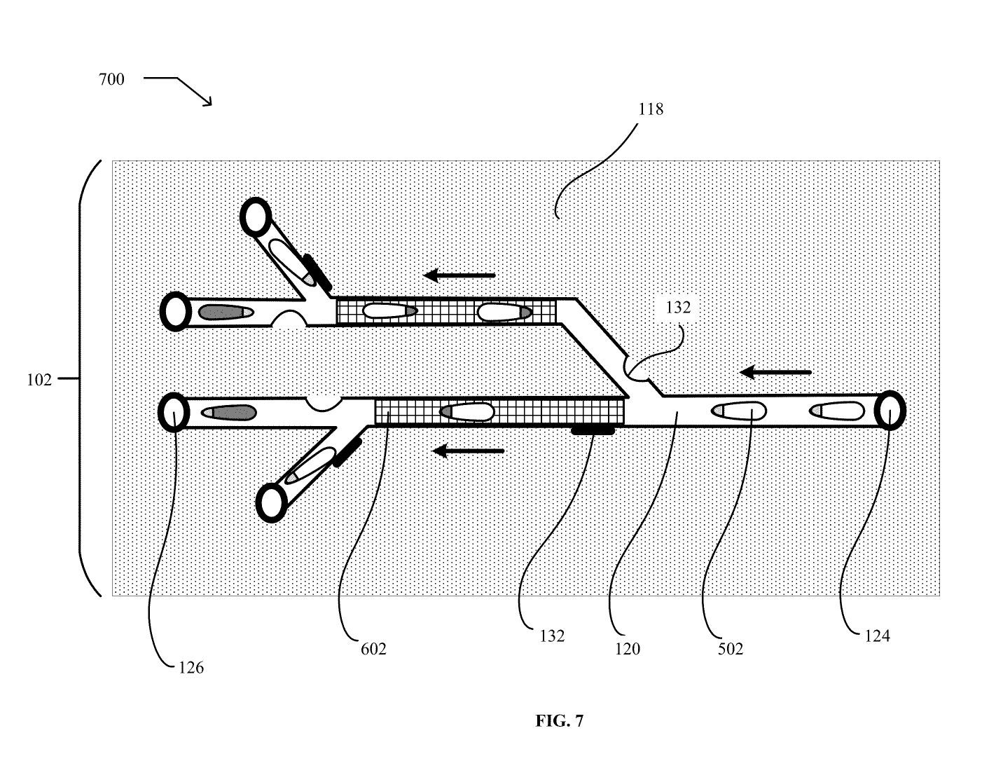

In some embodiments, a flow unit 102 may include one or more inlet sorting chambers 128. An inlet sorting chamber 128 may be configured in numerous ways. For example, in some embodiments, an inlet sorting chamber 128 may be configured to include a flow channel 120 that is fluidly coupled to two or more branching flow channels 120 that are each operably coupled to one or more sorting actuators 132 that can be activated to selectively direct flow into one or more selected branching flow channels 120. Sorting actuators 132 may be configured in numerous ways. In some embodiments, a sorting actuator 132 may be fabricated from one or more piezoelectric materials that change conformation in response to the application of electric current to the one or more piezoelectric materials (see e.g., Chen et al., Microfluidic cell sorter with integrated piezoelectric actuator, Biomed Microdevices, 11:1223-1231 (2009) and Ramanamurthy et al., Piezoelectric microvalve, Indian Journal of Pure & Applied Physics, 45: 278-281 (2007)). Accordingly, in some embodiments, a piezoelectric sorting actuator 132 may be activated in order to obstruct a branching flow channel 120 to direct flow into a different branching flow channel 120 (see for example, FIG. 7). In some embodiments, a piezoelectric sorting actuator 132 may be activated in order to remove an obstruction in a branching flow channel 120 to direct flow into the branching flow channel 120 (see for example, FIG. 7). In some embodiments, the action of two or more piezoelectric sorting actuators 132 may be coupled together so that a first piezoelectric sorting actuator 132 may be activated to obstruct a first branching flow channel 120 and a second piezoelectric sorting actuator 132 may be activated to remove an obstruction to a second branching flow channel 120 to direct flow in the second branching flow channel 120 (see for example, FIG. 7). In some embodiments, a sorting actuator 132 may be operably coupled to a detection unit 106 to provide for sorting of one or more biological objects that are being transported through one or more flow channels 120. For example, in some embodiments, a detection unit 106 may be used to determine the anterior-posterior orientation of a mosquito embryo that is being transported through a flow channel 120. Accordingly, the detection unit 106 may activate one or more sorting actuators 132 to direct mosquito embryos that are being transported with the anterior portion first into a first flow channel 120 and direct mosquito embryos that are being transported with the posterior portion first into a second flow channel 120 (see for example, FIG. 7).

In some embodiments, a flow unit 102 may include one or more outlet sorting chambers 130. An outlet sorting chambers 130 may be configured in numerous ways. For example, in some embodiments, an outlet sorting chambers 130 may be configured to include a flow channel 120 that is fluidly coupled to two or more branching flow channels 120 that are each operably coupled to one or more sorting actuators 132 that can be activated to selectively direct flow into one or more selected branching flow channels 120. Sorting actuators 132 may be configured in numerous ways. In some embodiments, a sorting actuator 132 may be fabricated from one or more piezoelectric materials that change conformation in response to the application of electric current to the one or more piezoelectric materials (see e.g., Chen et al., Microfluidic cell sorter with integrated piezoelectric actuator, Biomed Microdevices, 11:1223-1231 (2009) and Ramanamurthy et al., Piezoelectric microvalve, Indian Journal of Pure & Applied Physics, 45: 278-281 (2007)). Accordingly, in some embodiments, a piezoelectric sorting actuator 132 may be activated in order to obstruct a branching flow channel 120 to direct flow into a different branching flow channel 120 (see for example, FIG. 7). In some embodiments, a piezoelectric sorting actuator 132 may be activated in order to remove an obstruction in a branching flow channel 120 to direct flow into the branching flow channel 120 (see for example, FIG. 7). In some embodiments, the action of two or more piezoelectric sorting actuators 132 may be coupled together so that a first piezoelectric sorting actuator 132 may be activated to obstruct a first branching flow channel 120 and a second piezoelectric sorting actuator 132 may be activated to remove an obstruction to a second branching flow channel 120 to direct flow in the second branching flow channel 120 (see for example, FIG. 7). In some embodiments, a sorting actuator 132 may be operably coupled to a detection unit 106 to provide for sorting of one or more biological objects that are being transported through one or more flow channels 120. For example, in some embodiments, a detection unit 106 may be used to detect one or more characteristics associated with a biological object and activate one or more sorting actuators 132 in one or more outlet sorting chambers 130 to sort the one or more biological objects in accordance with the detected characteristic. For example, in some embodiments, a detection unit 106 may determine if a biological object that is being transported through a flow channel 120 is structurally intact. Accordingly, in some embodiments, intact biological objects may be directed into a first branching flow channel 120 and biological objects that are not structurally intact may be directed into a second branching flow channel 120.

In some embodiments, a flow unit 102 may include one or more flow receivers 134. In some embodiments, a flow unit 102 may include one or more flow transmitters 136. In some embodiments, a flow unit 102 may include one or more flow processors 138. Accordingly, in some embodiments, a flow unit 102 may receive one or more signals 108. In some embodiments, a flow unit 102 may transmit one or more signals 108. In some embodiments, a flow unit 102 may process one or more signals 108. For example, in some embodiments, a flow unit 102 may receive one or more signals 108 that were transmitted by one or more detection units 106. In some embodiments, a flow unit 102 may receive one or more signals 108 that were transmitted by one or more detection units 106 that instruct the flow unit 102 to operate one or more sorting actuators 132. In some embodiments, a flow unit 102 may receive one or more signals 108 that were transmitted by one or more system control units 112. In some embodiments, a flow unit 102 may receive one or more signals 108 that were transmitted by one or more system control units 112 that instruct the flow unit 102 to operate one or more sorting actuators 132. In some embodiments, a flow unit 102 may receive one or more signals 108 that were transmitted by one or more user interfaces 114. In some embodiments, a flow unit 102 may receive one or more signals 108 that were transmitted by one or more user interfaces 114 that instruct the flow unit 102 to operate one or more sorting actuators 132. In some embodiments, a flow unit 102 may transmit one or more signals 108. For example, in some embodiments, a flow unit 102 may transmit one or more signals 108 that indicate the status of one or more sorting actuators 132.

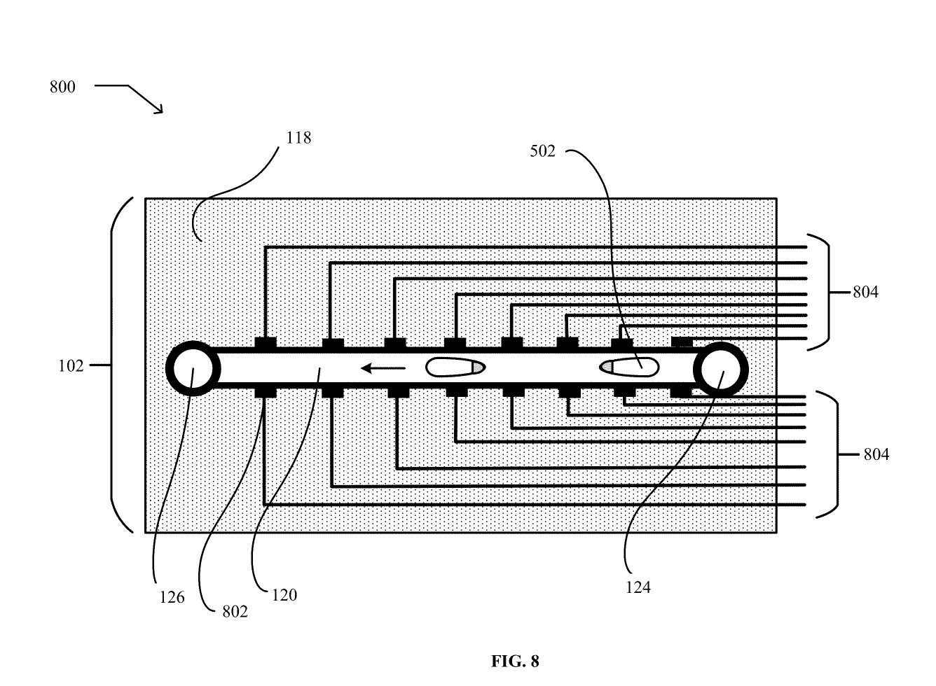

In some embodiments, a flow unit 102 may include one or more electrodes that are operably coupled to one or more flow channels 120 (see for example, FIG. 8). In some embodiments, the one or more electrodes may be configured for use as electrical resistance detectors 176. In some embodiments, the one or more electrodes may be configured for use as electrical conductance detectors 174. In some embodiments, the one or more electrodes may be configured for use as capacitance detectors 254. In some embodiments, the one or more electrodes may be operably couplable to a microwave generator 222 to direct microwave energy into one or more flow channels 120. In some embodiments, a flow unit 102 may include one or more ultrasonic probes that are operably coupled to one or more flow channels 120. In some embodiments, the one or more ultrasonic probes may be operably couplable to one or more ultrasonic drivers 226 to direct ultrasonic energy into the one or more flow channels 120. In some embodiments, a flow unit 102 may include one or more radiofrequency probes that are operably coupled to one or more flow channels 120. In some embodiments, the one or more radiofrequency probes may be operably couplable to one or more radiofrequency generators 224 to direct radiofrequency energy into the one or more flow channels 120.

### Fluid Control Unit

In some embodiments, system 100 may include one or more fluid control units 104. In some embodiments, a fluid control unit 104 may be operably coupled to a flow unit 102 and used to supply the flow unit 102 with one or more carrier fluids. Accordingly, in some embodiments, a fluid control unit 104 may include one or more carrier fluid reservoirs 160. In some embodiments, a fluid control unit 104 may be operably coupled to a flow unit 102 and used to control the flow of one or more carrier fluids through the flow unit 102.

In some embodiments, a fluid control unit 104 may include one or more pumps 148. In some embodiments, a fluid control unit 104 may include numerous types of pumps 148 and combinations of pumps 148. Examples of pumps 148 include, but are not limited to, pressure pumps 150, volumetric pumps 152, piston pumps 154, peristaltic pumps 156, syringe pumps 158, and the like. In some embodiments, a pump 148 may include one or more piezioelectric motors (see e.g., Henderson, Novel Piezo Motor Enables Positive Displacement Microfluidic Pump, Nanotech, Technical Proceedings of the 2007 NSTI Nanotechnology Conference and Trade Show, 3(4): 272-275 (2007)). In some embodiments, a pump 148 may include one or more stepper motors.

In some embodiments, a flow control unit 104 may include one or more fluid receivers 142. In some embodiments, a flow control unit 104 may include one or more fluid transmitters 144. In some embodiments, a flow control unit 104 may include one or more fluid processors 146. Accordingly, in some embodiments, a fluid control unit 104 may receive one or more signals 108. In some embodiments, a fluid control unit 104 may transmit one or more signals 108. In some embodiments, a fluid control unit 104 may process one or more signals 108. For example, in some embodiments, a fluid control unit 104 may receive one or more signals 108 that are were transmitted by an emission unit 110. In some embodiments, a fluid control unit 104 may receive one or more signals 108 that were transmitted by a flow unit 102. In some embodiments, a fluid control unit 104 may receive one or more signals 108 that were transmitted by a detection unit 106. In some embodiments, a fluid control unit 104 may receive one or more signals 108 that were transmitted by a system control unit 112. In some embodiments, a fluid control unit 104 may receive one or more signals 108 that were transmitted by a user interface 114.

In some embodiments, a fluid control unit 104 may receive one or more signals 108 that include one or more instructions associated with controlling the rate of flow of one or more carrier fluids through a flow unit 102. For example, in some embodiments, a flow unit 102 may transmit one or more signals 108 that include information associated with the flow rate of one or more carrier fluids through the flow unit 102. In some embodiments, such signals 108 may be received by a fluid control unit 104 that will process the one or more signals 108 and then control the operation of one or more pumps 148 in response to the information. In some embodiments, a fluid control unit 104 may receive one or more signals 108 that were transmitted by one or more detection units 106 that include instructions associated with controlling the flow of one or more carrier fluids through the flow unit 102. In some embodiments, a fluid control unit 104 may receive one or more signals 108 that were transmitted by one or more emission units 110 that include instructions associated with controlling the flow of one or more carrier fluids through the flow unit 102. In some embodiments, a fluid control unit 104 may receive one or more signals 108 that were transmitted by one or more user interfaces 114 that include instructions associated with controlling the flow of one or more carrier fluids through the flow unit 102.

### Detection Unit

In some embodiments, system 100 may include one or more detection units 106. Detection units 106 may be configured in numerous ways. In some embodiments, a detection unit 106 may be configured to dynamically determine the position of one or more biological objects that are being transported through one or more flow channels 120 in one or more carrier fluids. In some embodiments, a detection unit 106 may be configured to determine multiple positions of a biological object as it is being transported through a flow channel 120 in a carrier fluid. For example, a detection unit 106 may determine the position of a biological object at a first time point and then determine the position of the biological object at one or more later time points. In some embodiments, a detection unit 106 may be configured to determine the velocity of one or more biological objects that are being transported through one or more flow channels 120 in one or more carrier fluids. For example, in some embodiments, the velocity of a biological object may be determined by detecting the position of the biological object at two or more different time points and then determining the distance travelled versus time. Accordingly, in some embodiments, a detection unit 106 may be configured to determine the position and velocity of one or more biological objects that are being transported through one or more flow channels 120 in one or more carrier fluids. In some embodiments, a detection unit 106 may predict a future position of a biological object that is being transported through a flow channel 120 based on the position and velocity of the biological object. Accordingly, in some embodiments, a detection unit 106 may dynamically determine the position of a biological object that is being transported through a flow channel 120. In some embodiments, a detection unit 106 may be configured to determine the orientation of one or more biological objects that are being transported through one or more flow channels 120 in one or more carrier fluids.

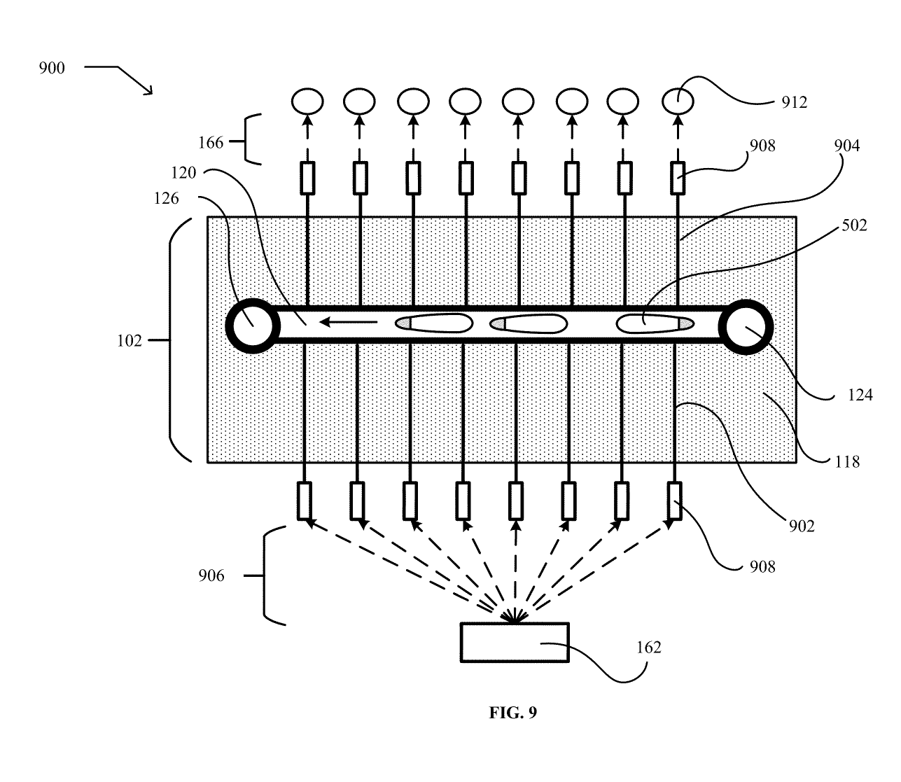

A detection unit 106 may be configured in numerous ways to detect one or more biological objects that are being transported through one or more flow channels 120 in one or more carrier fluids. In some embodiments, a detection unit 106 may include one or more microscopes 168. Accordingly, in some embodiments, a detection unit 106 may utilize microscopic methods to detect one or more biological objects. Examples of microscopic methods include, but are not limited to, bright field microscopy, confocal microscopy, dark field microscopy, digital microscopy, fluorescence interference contrast microscopy, fluorescence microscopy, multifocal plane microscopy, phase contrast microscopy, and the like. In some embodiments, a microscope 168 may include one or more objectives 164. In some embodiments, a detection unit 106 may include one or more spectrometers 172. Accordingly, in some embodiments, a detection unit 106 may utilize spectroscopic methods to detect one or more biological objects. Examples of such spectroscopic methods include, but are not limited to, circular dichroism spectroscopy, ultraviolet/visible spectroscopy, infrared spectroscopy, absorption spectroscopy, transmission spectroscopy, and the like. In some embodiments, a detection unit 106 may utilize one or more cameras 170 to detect one or more biological objects. In some embodiments, a detection unit 106 may utilize one or more charge coupled devices to detect one or more biological objects. In some embodiments, a detection unit 106 may acquire one or more images of a biological object and then compare the one or more images to one or more images that are stored in a database. For example, in some embodiments, a detection unit 106 may acquire one or more images of a mosquito embryo and then compare those images to one or more images of a mosquito embryo that are stored in a database. In some embodiments, a detection unit 106 may determine the position of a biological object by detecting the position of the biological object relative to one or more fiducial markers 122 that are at known positions along the length of a flow channel 120 (see e.g., FIG. 5) (see e.g., U.S. Pat. No. 8,367,016). In some embodiments, a detection unit 106 may determine the position of a biological object by detecting the position of the biological object relative to a calibrated grid pattern that indicates known positions along the length of a flow channel 120 (see e.g., FIG. 6). In some embodiments, the position of a biological object in a flow channel 120 may be determined through use of an array of optical fibers and photodiodes 166 that are associated with the flow channel 120 (see for example, FIG. 9). In some embodiments, a flow unit 102 may include an array of optical fibers that are each at a known position along the length of a flow channel 120 that is included within the flow unit 102. Light may be transmitted by an optical fiber on one side of the flow channel 120 to a paired optical fiber on the other side of the flow channel 120 and then detected through use of a photodiode (see e.g., Schafer et al., Microfluidic cell counter with embedded optical fibers fabricated by femtosecond laser ablation and anodic bonding, Optics Express, 17(8): 6068-6073 (2009)). Accordingly, in some embodiments, the position of a biological object that is being transported through the flow channel 120 may be determined by detecting light scattering at a known position along the length of the flow channel 120 that is caused by passage of the biological object at that position in the flow channel 120. In some embodiments, the position of a biological object that is being transported through the flow channel 120 may be determined by detecting one or more spectroscopic changes that occur at a known position along the length of the flow channel 120 that are caused by passage of the biological object at that position in the flow channel 120.

In some embodiments, the position of a biological object in a flow channel 120 may be determined through use of an array of paired electrodes that are associated with the flow channel 120 (see for example, FIG. 8). In some embodiments, a flow unit 102 may include an array of paired electrodes that are at known positions along the length of a flow channel 120 that is included within the flow unit 102. Electrical current may be applied to each of the paired electrodes and then measured. Accordingly, in some embodiments, the position of a biological object that is being transported through the flow channel 120 may be determined by detecting altered electrical resistance and/or conductance occurring at a known position along the length of the flow channel 120 that is caused by passage of the biological object at that position in the flow channel 120. Accordingly, in some embodiments, a detection unit 106 may include one or more electrical conductance detectors 174. In some embodiments, a detection unit 106 may include one or more electrical resistance detectors 176. In some embodiments, a detection unit 106 may include one or more capacitance detectors 254.

In some embodiments, a detection unit 106 may be configured to determine the anterior-posterior orientation of a biological object being transported through a flow channel 120. In some embodiments, a detection unit 106 may be configured to determine the anterior-posterior orientation of a mosquito embryo that is being transported through a flow channel 120. For example, in some embodiments, a detection unit 106 may detect the position of a mosquito embryo that is being transported through a flow channel 120 by comparing the detected position of the mosquito embryo to a calibrated grid pattern that indicates known positions along the length of the flow channel 120. In such an embodiment, the anterior-posterior orientation of the mosquito embryo in the flow channel 120 may be determined by comparing cross-sectional diameters that are detected along the length of the mosquito embryo to a calibrated grid pattern that indicates known positions across the width of the flow channel 120. Accordingly, in some embodiments, the anterior-posterior orientation of the mosquito embryo can be determined by detecting the width of the mosquito embryo at each of the poles of the mosquito embryo with the pole having the greater width being the anterior pole and the pole having the smaller width being the posterior pole of the mosquito embryo (see for example, FIG. 6).

In some embodiments, a detection unit 106 may detect one or more properties associated with one or more biological objects. In some embodiments, the expression of a marker protein by a biological object may be detected. For example, in some embodiments, the expression of green fluorescent protein by a cell may be detected. In some embodiments, the uptake of a fluorescent tag by a biological object may be detected. For example, in some embodiments, the uptake of a fluorescent dye by a cell may be detected.

In some embodiments, a detection unit 106 may include one or more detector receivers 184. In some embodiments, a detection unit 106 may include one or more detector transmitters 186. In some embodiments, a detection unit 106 may include one or more detector processors 178. In some embodiments, a detection unit 106 may include detector memory 182. In some embodiments, a detection unit 106 may include detector logic 180. Accordingly, in some embodiments, a detection unit 106 may receive one or more signals 108. In some embodiments, a detection unit 106 may transmit one or more signals 108. In some embodiments, a detection unit 106 may process one or more signals 108. For example, in some embodiments, a detection unit 106 may determine the position of a biological object being transported through a flow channel 120 and then transmit one or more signals 108 that indicate the position of the biological object. In some embodiments, a detection unit 106 may determine the velocity of a biological object being transported through a flow channel 120 and then transmit one or more signals 108 that indicate the velocity of the biological object. In some embodiments, a detection unit 106 may determine the position and velocity of a biological object being transported through a flow channel 120 and then transmit one or more signals 108 that indicate the position and velocity of the biological object. In some embodiments, a detection unit 106 may determine two or more positions of a biological object being transported through a flow channel 120 at two or more different times and then transmit one or more signals 108 that indicate the positions of the biological object at the different times.

In some embodiments, a detection unit 106 may determine the position of a biological object being transported through a flow channel 120 and then transmit one or more signals 108 that instruct one or more emission units 110 to direct focused energy to cause at least one cavitation induced perforation in the biological object based on the position of the biological object in the flow channel 120. In some embodiments, a detection unit 106 may determine the position and velocity of a biological object being transported through a flow channel 120 and then transmit one or more signals 108 that instruct one or more emission units 110 to direct focused energy to cause at least one cavitation induced perforation in the biological object. In some embodiments, a detection unit 106 may use detector logic 180 to predict one or more positions of a biological object at one or more future times based on the position and velocity of the biological object and then transmit one or more signals 108 that instruct one or more emission units 110 to direct focused energy at the one or more future times to cause at least one cavitation induced perforation in the biological object. Accordingly, in some embodiments, one or more detection units 106 may dynamically determine the position of one or more biological objects as they are transported through one or more flow channels 120.

In some embodiments, a detection unit 106 may transmit one or more signals 108 that instruct an emission unit 110 to direct focused energy at a portion of a biological object. For example, in some embodiments, a detection unit 106 may determine the position of the posterior portion of a mosquito embryo that is being transported through a flow channel 120 and the velocity with which the mosquito embryo is being transported. The detection unit 106 may then predict one or more future positions of the posterior portion of a mosquito embryo in the flow channel 120 at one or more future times. The detection unit 106 may then transmit one or more signals 108 based on the one or more predicted positions of the posterior portion of the mosquito embryo that instruct one or more emission units 110 to direct focused energy at the posterior portion of the mosquito embryo to cause at least one cavitation induced perforation in the posterior portion of the mosquito embryo. In some embodiments, the one or more detection units 106 may transmit one or more such signals 108 that instruct one or more emission units 110 to direct laser light at the posterior portion of the mosquito embryo to cause at least one cavitation induced perforation in the posterior portion of the mosquito embryo. In some embodiments, the one or more detection units 106 may transmit one or more such signals 108 that instruct one or more emission units 110 to direct laser light at a position adjacent to the posterior portion of the mosquito embryo to cause at least one cavitation induced perforation in the posterior portion of the mosquito embryo.

In some embodiments, a detection unit 106 may transmit one or more signals 108 that are received by one or more system control units 112. In some embodiments, a detection unit 106 may transmit one or more signals 108 that are received by one or more user interfaces 114. For example, in some embodiments, a detection unit 106 may transmit one or more signals 108 that indicate the position of one or more biological objects that are being transported through a flow channel 120. In some embodiments, a detection unit 106 may transmit one or more signals 108 that indicate the position of one or more portions of one or more biological objects that are being transported through a flow channel 120. For example, in some embodiments, a detection unit 106 may transmit one or more signals 108 that indicate the position of the posterior portion of a mosquito embryo. In some embodiments, a detection unit 106 may transmit one or more signals 108 that indicate the velocity of one or more biological objects that are being transported through a flow channel 120. In some embodiments, a detection unit 106 may transmit one or more signals 108 that indicate the position and velocity of one or more biological objects that are being transported through a flow channel 120. In some embodiments, a detection unit 106 may transmit one or more signals 108 that indicate the orientation of one or more biological objects that are being transported through a flow channel 120. In some embodiments, a detection unit 106 may transmit one or more signals 108 that indicate one or more predicted positions at one or more future times of one or more biological objects that are being transported through a flow channel 120. In some embodiments, a detection unit 106 may transmit one or more signals 108 that indicate one or more predicted positions at one or more future times of one or more portions of one or more biological objects that are being transported through a flow channel 120. For example, in some embodiments, a detection unit 106 may transmit one or more signals 108 that indicate one or more predicted positions at one or more future times of the posterior portion of a mosquito embryo that is being transported through a flow channel 120.

In some embodiments, a detection unit 106 may transmit one or more signals 108 that are received by one or more flow units 102. For example, in some embodiments, a detection unit 106 may transmit one or more signals 108 that instruct a flow unit 102 to increase the rate of flow of a carrier fluid through a flow channel 120. In some embodiments, a detection unit 106 may transmit one or more signals 108 that instruct a flow unit 102 to decrease the rate of flow of a carrier fluid through a flow channel 120.

In some embodiments, a detection unit 106 may receive one or more signals 108. In some embodiments, a detection unit 106 may receive one or more signals 108 that were transmitted by a flow unit 102. For example, in some embodiments, a detection unit 106 may receive one or more signals 108 that indicate the flow rate of a carrier fluid through a flow channel 120. In some embodiments, a detection unit 106 may receive one or more signals 108 that were transmitted by a fluid control unit 104. For example, in some embodiments, a detection unit 106 may receive one or more signals 108 that indicate the operating level of one or more pumps 148. In some embodiments, a detection unit 106 may receive one or more signals 108 that were transmitted by an emission unit 110. For example, in some embodiments, a detection unit 106 may receive one or more signals 108 that indicate when an emission unit 110 emitted focused energy. In some embodiments, a detection unit 106 may receive one or more signals 108 that indicate where an emission unit 110 emitted focused energy. In some embodiments, a detection unit 106 may receive one or more signals 108 that were transmitted by a system control unit 112. For example, in some embodiments, a detection unit 106 may receive one or more signals 108 that instruct the detection unit 106 to obtain one or more images of a biological object being transported though a flow channel 120. In some embodiments, a detection unit 106 may receive one or more signals 108 that were transmitted by a user interface 114. For example, in some embodiments, a detection unit 106 may receive one or more signals 108 that instruct the detection unit 106 to transmit one or more signals 108 that include one or more images of a biological object that is being transported though a flow channel 120.

### Signal

Numerous types of signals 108 may be utilized within system 100. Examples of such signals 108 include, but are not limited to, wireless signals 188, optical signals 190, magnetic signals 192, Bluetooth signals 194, radiofrequency signals 196, hardwired signals 189, infrared signals 200, audible signals 202, digital signals 204, analog signals 206, and the like.

### Emission Unit

In some embodiments, system 100 may include one or more emission units 110. In some embodiments, one or more emission units 110 may be configured to direct focused energy to cause at least one cavitation induced perforation in at least one biological object that is being transported through a flow channel 120. Emission units 110 may be configured in numerous ways to emit numerous types of focused energy. Examples of focused energy include, but are not limited to, microwave energy, laser light energy, radiofrequency energy, ultrasonic energy, and the like. In some embodiments, a single type of focused energy may be used to cause at least one cavitation induced perforation in at least one biological object. In some embodiments, one or more types of focused energy may be used to cause at least one cavitation induced perforation in at least one biological object. For example, in some embodiments, microwave energy and laser light may be used to cause at least one cavitation induced perforation in at least one biological object. In some embodiments, ultrasonic energy and radiofrequency energy may be used to cause at least one cavitation induced perforation in at least one biological object

In some embodiments, an emission unit 110 may be configured to emit microwaves to cause cavitation. Accordingly, in some embodiments, an emission unit 110 may include one or more microwave generators 222. In some embodiments, a microwave generator 222 may include a magnetron. In some embodiments, a microwave generator 222 may include a tunable magnetron. In some embodiments, a microwave generator 222 may include a magnetron that provides a microwave field that is passed through a waveguide to allow the microwave energy to be directed and focused. In some embodiments, a microwave generator 222 may be operably coupled to one or more probes that are associated with a flow channel 120 such that microwave energy may be directed into the flow channel 120 to produce cavitation (see e.g., Rassaei et al, Discharge cavitation during microwave electrochemistry at micrometre-sized electrodes, Chem. Commun., 46(5): 812-814 (2010)). In some embodiments, an emission unit 110 may include one or more collimators that may be used to focus microwaves (see e.g., Greegor et al, microwave focusing and beam collimation using negative index of refraction lenses, IET Microw. Antennas Propag., 1(1): 108-115 (2007)).

In some embodiments, an emission unit 110 may be configured to emit ultrasonic energy to cause cavitation (see e.g., Suslick et al., Acoustic cavitation and its chemical consequences, Phil. Trans. R. Soc. Lond. A., 357: 335-353 (1999), Louisnard and Gonzalez-Garcia, Acoustic Cavitation, Ultrasound Technologies for Food and Bioprocessing, 2:13-64 (2011), and U.S. Pat. No. 7,425,792). In some embodiments, an emission unit 110 may include one or more ultrasonic drivers 226. In some embodiments, an emission unit 110 may include one or more ultrasonic drivers 226 that include one or more piezoelectric transducers (see e.g., U.S. Pat. No. 7,049,730). In some embodiments, an emission unit 110 may include one or more ultrasonic drivers 226 that include one or more magnetostrictive transducers. In some embodiments, an emission unit 110 may include one or more driver assemblies that are operably coupled with one or more flow channels 120 and configured to direct ultrasonic energy into the one or more flow channels 120. In some embodiments, an emission unit 110 may include one or more collimators that may be used to focus ultrasonic energy.

In some embodiments, an emission unit 110 may be configured to emit radiofrequency energy to cause cavitation (see e.g., U.S. Published Patent Application Number: 20020060207). In some embodiments, an emission unit 110 may include one or more radiofrequency generators 224. In some embodiments, an emission unit 110 may include one or more radiofrequency generators 224 that are operably coupled to one or more probes that are operably coupled with one or more flow channels 120 and configured to direct radiofrequency energy into the one or more flow channels 120 to produce cavitation.

In some embodiments, an emission unit 110 may be configured to emit light to cause cavitation. In some embodiments, an emission unit 110 may include a light generator 218. In some embodiments, an emission unit 110 may be configured to emit laser light to cause cavitation. An emission unit 110 may include numerous types of lasers 220. Examples of such lasers 220 include, but are not limited to, pulsed lasers 220, neodymium-doped yttrium aluminum garnet (Nd:YAG) lasers 220, ruby lasers 220, gas lasers 220, chemical lasers 220, excimer lasers 220, solid-state lasers 220, fiber lasers 220, photonic crystal lasers 220, semiconductor lasers 220, dye lasers 220, free-electron lasers 220, and the like (see e.g., Li et al., A single-cell membrane dynamic from poration to restoration by bubble-induced jetting flow, Proceeding of μTAS2011, Seattle, USA, pp. 94-96 (2011)). In some embodiments, an emission unit 110 may include one or more lasers 220 and one or more lenses that may be used to focus laser light. In some embodiments, an emission unit 110 may include one or more lasers 220 and one or more collimators that may be used to focus laser light.

In some embodiments, an emission unit 110 may include one or more emission receivers 216. In some embodiments, an emission unit 110 may include one or more emission transmitters 214. In some embodiments, an emission unit 110 may include one or more emission processors 208. In some embodiments, an emission unit 110 may include emission memory 210. In some embodiments, an emission unit 110 may include emission logic 212. Accordingly, in some embodiments, an emission unit 110 may receive one or more signals 108. In some embodiments, an emission unit 110 may transmit one or more signals 108. In some embodiments, an emission unit 110 may process one or more signals 108. For example, in some embodiments, an emission unit 110 may receive one or more signals 108 that are transmitted by a detection unit 106. In some embodiments, an emission unit 110 may receive one or more signals 108 that are transmitted by a detection unit 106 that indicate the position of one or more biological objects being transported through one or more flow channels 120. In some embodiments, an emission unit 110 may receive one or more signals 108 that are transmitted by a detection unit 106 that indicate the position and velocity of one or more biological objects being transported through one or more flow channels 120. In some embodiments, an emission unit 110 may receive one or more signals 108 that are transmitted by a system control unit 112. In some embodiments, an emission unit 110 may receive one or more signals 108 that are transmitted by a system control unit 112 that indicate the position of one or more biological objects being transported through one or more flow channels 120. In some embodiments, an emission unit 110 may receive one or more signals 108 that were transmitted by a system control unit 112 that indicate the position and velocity of one or more biological objects being transported through one or more flow channels 120. Accordingly, in some embodiments, an emission unit 110 may process one or more signals 108 and then use the position information to direct focused energy to cause at least one cavitation induced perforation in at least one biological object. In some embodiments, an emission unit 110 may process the one or more signals 108 and then use the position and velocity information to direct focused energy to cause at least one cavitation induced perforation in at least one biological object. In some embodiments, an emission unit 110 may receive one or more signals 108 transmitted by a system control unit 112 that instruct the emission unit 110 to direct focused energy to cause at least one cavitation induced perforation in at least one biological object. In some embodiments, an emission unit 110 may receive one or more signals 108 transmitted by a user interface 114 that instruct the emission unit 110 to direct focused energy to cause at least one cavitation induced perforation in at least one biological object. In some embodiments, an emission unit 110 may receive one or more signals 108 transmitted by a detection unit 106 that instruct the emission unit 110 to direct focused energy to cause at least one cavitation induced perforation in at least one biological object.

In some embodiments, an emission unit 110 may transmit one or more signals 108. In some embodiments, an emission unit 110 may transmit one or more signals 108 that indicate where the emission unit 110 emitted focused energy. In some embodiments, an emission unit 110 may transmit one or more signals 108 that indicate when the emission unit 110 emitted focused energy. In some embodiments, an emission unit 110 may transmit one or more signals 108 that indicate the intensity of focused energy emitted by the emission unit 110.

### System Control Unit

In some embodiments, system 100 may include one or more system control units 112. In some embodiments, a system control unit 112 may include one or more control receivers 234. Accordingly, in some embodiments, a system control unit 112 may receive one or more signals 108. In some embodiments, a system control unit 112 may include one or more control transmitters 236. Accordingly, in some embodiments, a system control unit 112 may transmit one or more signals 108. In some embodiments, a system control unit 112 may include one or more control processors 228. Accordingly, in some embodiments, a system control unit 112 may process one or more signals 108. In some embodiments, a system control unit 112 may include control memory 232. In some embodiments, a system control unit 112 may include control logic 230.

In some embodiments, a system control unit 112 may be configured to control the operation of one or more flow units 102. For example, in some embodiments, a system control unit 112 may be configured to control the operation of one or more sorting actuators 132.

In some embodiments, a system control unit 112 may be configured to control the operation of one or more fluid control units 104. For example, in some embodiments, a system control unit 112 may be configured to control the operation of one or more pumps 148.

In some embodiments, a system control unit 112 may be configured to control the operation of one or more detection units 106. In some embodiments, a system control unit 112 may be configured to control the operation of one or more light sources 162. For example, in some embodiments, a system control unit 112 may be configured to control the wavelength of light emitted from one or more light sources 162. In some embodiments, a system control unit 112 may be configured to control the frequency with which light is emitted from one or more light sources 162. For example, in some embodiments, light may be emitted constantly from a light source 162. In some embodiments, light may be emitted from a light source 162 in pulses. In some embodiments, a system control unit 112 may be configured to control the intensity with which light is emitted from one or more light sources 162. In some embodiments, a system control unit 112 may be configured to control the operation of one or more photodiodes 166. For example, in some embodiments, a system control unit 112 may be configured to adjust the sensitivity of a photodiode 166. In some embodiments, a system control unit 112 may be configured to control the operation of one or more microscopes 168. For example, in some embodiments, a system control unit 112 may control the magnification used by the microscope 168. In some embodiments, a system control unit 112 may control the mode used by the microscope 168 (e.g., dark field). In some embodiments, a system control unit 112 may be configured to control the operation of one or more cameras 170. For example, in some embodiments, a system control unit 112 may control the shutter speed of the camera 170. In some embodiments, a system control unit 112 may control the field of view of the camera 170. In some embodiments, a system control unit 112 may be configured to control the operation of one or more spectrometers 172. For example, in some embodiments, a system control unit 112 may control one or more wavelengths of light emitted and/or detected by the spectrophotometer 172. In some embodiments, a system control unit 112 may control the scan speed used by the spectrophotometer 172.

In some embodiments, a system control unit 112 may be configured to control the operation of one or more conductance detectors 174. In some embodiments, a system control unit 112 may be configured to control the operation of one or more resistance detectors 176. In some embodiments, a system control unit 112 may be configured to control the operation of one or more capacitance detectors 254.

In some embodiments, a system control unit 112 may be configured to control the operation of one or more emission units 110. In some embodiments, a system control unit 112 may be configured to control the direction in which focused energy is emitted from one or more emission units 110.

In some embodiments, a system control unit 112 may be configured to control the operation of one or more light generators 218. In some embodiments, a system control unit 112 may be configured to control the operation of one or more light generators 218 that are one or more lasers 220. For example, in some embodiments, a system control unit 112 may be configured to select one or more wavelengths of light that are emitted from one or more light generators 218. In some embodiments, a system control unit 112 may be configured to control the duration of light emitted from one or more light generators 218. In some embodiments, a system control unit 112 may be configured to control the frequency with which light is emitted from one or more light generators 218. For example, in some embodiments, a system control unit 112 may be configured to cause light to be emitted constantly from one or more light generators 218. In some embodiments, a system control unit 112 may be configured to cause light to be emitted in pulses from one or more light generators 218. In some embodiments, a system control unit 112 may be configured to control the intensity of light that is emitted from one or more light generators 218.

In some embodiments, a system control unit 112 may be configured to control the operation of one or more microwave generators 222. In some embodiments, a system control unit 112 may be configured to control the duration of microwave energy emitted from one or more microwave generators 222. In some embodiments, a system control unit 112 may be configured to control the frequency with which microwave energy is emitted from one or more microwave generators 222. For example, in some embodiments, a system control unit 112 may be configured to cause microwave energy to be emitted constantly from one or more microwave generators 222. In some embodiments, a system control unit 112 may be configured to cause microwave energy to be emitted in pulses from one or more microwave generators 222. In some embodiments, a system control unit 112 may be configured to control the intensity of microwave energy that is emitted from one or more microwave generators 222.

In some embodiments, a system control unit 112 may be configured to control the operation of one or more radiofrequency generators 224. In some embodiments, a system control unit 112 may be configured to control the duration of radiofrequency energy emitted from one or more radiofrequency generators 224. In some embodiments, a system control unit 112 may be configured to control the frequency with which radiofrequency energy is emitted from one or more radiofrequency generators 224. For example, in some embodiments, a system control unit 112 may be configured to cause radiofrequency energy to be emitted constantly from one or more radiofrequency generators 224. In some embodiments, a system control unit 112 may be configured to cause radiofrequency energy to be emitted in pulses from one or more radiofrequency generators 224. In some embodiments, a system control unit 112 may be configured to control the intensity of radiofrequency energy that is emitted from one or more radiofrequency generators 224.

In some embodiments, a system control unit 112 may be configured to control the operation of one or more ultrasonic drivers 226. In some embodiments, a system control unit 112 may be configured to control the duration of ultrasonic energy emitted from one or more ultrasonic drivers 226. In some embodiments, a system control unit 112 may be configured to control the frequency with which ultrasonic energy is emitted from one or more ultrasonic drivers 226. For example, in some embodiments, a system control unit 112 may be configured to cause ultrasonic energy to be emitted constantly from one or more ultrasonic drivers 226. In some embodiments, a system control unit 112 may be configured to cause ultrasonic energy to be emitted in pulses from one or more ultrasonic drivers 226. In some embodiments, a system control unit 112 may be configured to control the intensity of ultrasonic energy that is emitted from one or more ultrasonic drivers 226.

In some embodiments, a system control unit 112 may receive one or more signals 108 that are transmitted by one or more flow units 102. For example, in some embodiments, a system control unit 112 may receive one or more signals 108 that indicate the status of one or more sorting actuators 132. In some embodiments, a system control unit 112 may receive one or more signals 108 that indicate the flow rate of one or more carrier fluids through one or more flow channels 120.

In some embodiments, a system control unit 112 may receive one or more signals 108 that are transmitted by one or more fluid control units 104. For example, in some embodiments, a system control unit 112 may receive one or more signals 108 that indicate the operating status of one or more pumps 148.

In some embodiments, a system control unit 112 may receive one or more signals 108 that are transmitted by one or more detection units 106. For example, in some embodiments, a system control unit 112 may receive one or more signals 108 that indicate the operating status of one or more light sources 162. For example, in some embodiments, a system control unit 112 may receive one or more signals 108 that indicate the intensity of light being emitted from a light source 162. In some embodiments, a system control unit 112 may receive one or more signals 108 that indicate the operating status of one or more photodiodes 166. For example, in some embodiments, a system control unit 112 may receive one or more signals 108 that indicate the sensitivity level under which a photodiode 166 is operating. In some embodiments, a system control unit 112 may receive one or more signals 108 that indicate the operating status of one or more microscopes 168. For example, in some embodiments, a system control unit 112 may receive one or more signals 108 that indicate the magnification level under which a microscope 168 is operating. In some embodiments, a system control unit 112 may receive one or more signals 108 that indicate the operating status of one or more cameras 170. For example, in some embodiments, a system control unit 112 may receive one or more signals 108 that indicate the field of view under which a camera 170 is operating. In some embodiments, a system control unit 112 may receive one or more signals 108 that indicate the operating status of one or more spectrometers 172. For example, in some embodiments, a system control unit 112 may receive one or more signals 108 that indicate one or more wavelengths of light that the spectrophotometer 172 is measuring. In some embodiments, a system control unit 112 may receive one or more signals 108 that indicate the operating status of one or more electrical conductance detectors 174. In some embodiments, a system control unit 112 may receive one or more signals 108 that indicate the operating status of one or more electrical resistance detectors 176. In some embodiments, a system control unit 112 may receive one or more signals 108 that indicate the operating status of one or more capacitance detectors 254.

In some embodiments, a system control unit 112 may receive one or more signals 108 that are transmitted by one or more detection units 106 that indicate the position of one or more biological objects that are being transported through one or more flow channels 120. In some embodiments, a system control unit 112 may receive one or more signals 108 that are transmitted by one or more detection units 106 that indicate the velocity with which one or more biological objects are being transported through one or more flow channels 120. In some embodiments, a system control unit 112 may receive one or more signals 108 that are transmitted by one or more detection units 106 that indicate the position and velocity of one or more biological objects that are being transported through one or more flow channels 120. In some embodiments, a system control unit 112 may receive one or more signals 108 that are transmitted by one or more detection units 106 that indicate one or more predicted future positions at one or more futures times of one or more biological objects that are being transported through one or more flow channels 120. In some embodiments, a system control unit 112 may receive one or more signals 108 that are transmitted by one or more detection units 106 that indicate the orientation of one or more biological objects that are being transported through one or more flow channels 120. In some embodiments, a system control unit 112 may receive one or more signals 108 that are transmitted by one or more detection units 106 that indicate one or more predicted future positions at one or more futures times of one or more portions of one or more biological objects that are being transported through one or more flow channels 120. In some embodiments, a system control unit 112 may receive one or more signals 108 that are transmitted by one or more detection units 106 that indicate the anterior-posterior orientation of one or more mosquito embryos that are being transported through one or more flow channels 120. In some embodiments, a system control unit 112 may receive one or more signals 108 that are transmitted by one or more detection units 106 that indicate a predicted future position at one or more futures times of a posterior portion of a mosquito embryo that is being transported through one or more flow channels 120. In some embodiments, a system control unit 112 may receive one or more signals 108 that are transmitted by one or more detection units 106 that include information associated with one or more images. For example, in some embodiments, a system control unit 112 may receive one or more signals 108 that are transmitted by one or more detection units 106 that include information associated with one or more images of one or more biological objects.

In some embodiments, a system control unit 112 may receive one or more signals 108 that are transmitted by one or more emission units 110. For example, in some embodiments, a system control unit 112 may receive one or more signals 108 indicating one or more times when an emission unit 110 has emitted energy. In some embodiments, a system control unit 112 may receive one or more signals 108 indicating one or more positions where an emission unit 110 directed focused energy. In some embodiments, a system control unit 112 may receive one or more signals 108 indicating the intensity of focused energy that has been emitted. In some embodiments, a system control unit 112 may receive one or more signals 108 indicating the frequency with which focused energy has been emitted.

In some embodiments, a system control unit 112 may receive one or more signals 108 that are transmitted by one or more user interfaces 114. In some embodiments, a system control unit 112 may receive one or more signals 108 that include one or more instructions associated with controlling the operation of one or more flow units 102. For example, in some embodiments, a system control unit 112 may receive one or more signals 108 that include one or more instructions associated with controlling the operation of one or more sorting actuators 132. In some embodiments, a system control unit 112 may receive one or more signals 108 that include one or more instructions associated with controlling the operation of one or more fluid control units 104. For example, in some embodiments, a system control unit 112 may receive one or more signals 108 that include one or more instructions associated with controlling the operation of one or more pumps 148. In some embodiments, a system control unit 112 may receive one or more signals 108 that include one or more instructions associated with controlling the operation of one or more detection units 106. For example, in some embodiments, a system control unit 112 may receive one or more signals 108 that include one or more instructions associated with controlling the operation of one or more light sources 162. In some embodiments, a system control unit 112 may receive one or more signals 108 that include one or more instructions associated with controlling the operation of one or more photodiodes 166. In some embodiments, a system control unit 112 may receive one or more signals 108 that include one or more instructions associated with controlling the operation of one or more microscopes 168. In some embodiments, a system control unit 112 may receive one or more signals 108 that include one or more instructions associated with controlling the operation of one or more cameras 170. In some embodiments, a system control unit 112 may receive one or more signals 108 that include one or more instructions associated with controlling the operation of one or more spectrometers 172. In some embodiments, a system control unit 112 may receive one or more signals 108 that include one or more instructions associated with controlling the operation of one or more electrical resistance detectors 176. In some embodiments, a system control unit 112 may receive one or more signals 108 that include one or more instructions associated with controlling the operation of one or more electrical conductance detectors 174. In some embodiments, a system control unit 112 may receive one or more signals 108 that include one or more instructions associated with controlling the operation of one or more capacitance detectors 254.

In some embodiments, a system control unit 112 may transmit one or more signals 108 that are received by one or more flow units 102. For example, in some embodiments, a system control unit 112 may transmit one or more signals 108 that are associated with controlling the operation of one or more flow units 102. In some embodiments, a system control unit 112 may receive one or more signals 108 that were transmitted by one or more detection units 106 that indicate whether a biological object is intact or not intact after undergoing cavitation induced perforation. The system control unit 112 may then transmit one or more signals 108 that control the operation of a sorting actuator 132 to direct biological objects that are intact into a first branching flow channel 120 and biological objects that are not intact into a different branching flow channel 120. In some embodiments, a system control unit 112 may receive one or more signals 108 that were transmitted by one or more detection units 106 that indicate whether a mosquito embryo is being transported through a flow channel 120 in an anterior-posterior pole orientation or in a posterior-anterior pole orientation. The system control unit 112 may then transmit one or more signals 108 that control the operation of a sorting actuator 132 to direct mosquito embryos that are in an anterior-posterior pole orientation into a first branching flow channel 120 and mosquito embryos that are in a posterior-anterior pole orientation into a different branching flow channel 120 (see for example, FIG. 7). In some embodiments, a system control unit 112 may receive one or more signals 108 that were transmitted by one or more detection units 106 that indicate whether or not a biological object includes an article that entered the biological object through a cavitation induced perforation. The system control unit 112 may then transmit one or more signals 108 that control the operation of a sorting actuator 132 to direct biological objects that include the article into a first branching flow channel 120 and biological objects that do not include the article into a different branching flow channel 120 (see for example, FIG. 7).

In some embodiments, a system control unit 112 may transmit one or more signals 108 that are received by one or more fluid control units 104. In some embodiments, a system control unit 112 may transmit one or more signals 108 that are associated with controlling the operation of one or more fluid control units 104. In some embodiments, a system control unit 112 may transmit one or more signals 108 that are associated with controlling the operation of one or more pumps 148. For example, in some embodiments, a system control unit 112 may receive one or more signals 108 that were transmitted by a flow unit 102 that indicate the flow rate of a carrier fluid through a flow channel 120. The system control unit 112 may then transmit one or more signals 108 that control the operation of one or more pumps 148 to achieve a desired flow rate. In some embodiments, a system control unit 112 may receive one or more signals 108 that were transmitted by a detection unit 106 that indicate the velocity with which one or more biological objects are being transported through a flow channel 120. The system control unit 112 may then transmit one or more signals 108 that control the operation of one or more pumps 148 to achieve a desired velocity.

In some embodiments, a system control unit 112 may transmit one or more signals 108 that are received by one or more detection units 106. In some embodiments, a system control unit 112 may transmit one or more signals 108 that are associated with controlling the operation of one or more detection units 106. In some embodiments, a system control unit 112 may transmit one or more signals 108 that are associated with controlling the operation of one or more light sources 162. In some embodiments, a system control unit 112 may transmit one or more signals 108 that are associated with controlling the operation of one or more photodiodes 166. In some embodiments, a system control unit 112 may transmit one or more signals 108 that are associated with controlling the operation of one or more microscopes 168. In some embodiments, a system control unit 112 may transmit one or more signals 108 that are associated with controlling the operation of one or more cameras 170. In some embodiments, a system control unit 112 may transmit one or more signals 108 that are associated with controlling the operation of one or more spectrometers 172. In some embodiments, a system control unit 112 may transmit one or more signals 108 that are associated with controlling the operation of one or more electrical resistance detectors 176. In some embodiments, a system control unit 112 may transmit one or more signals 108 that are associated with controlling the operation of one or more electrical conductance detectors 174. In some embodiments, a system control unit 112 may transmit one or more signals 108 that are associated with controlling the operation of one or more capacitance detectors 254.

In some embodiments, a system control unit 112 may transmit one or more signals 108 that are received by one or more emission units 110. In some embodiments, a system control unit 112 may transmit one or more signals 108 that are associated with controlling the operation of one or more emission units 110. In some embodiments, a system control unit 112 may transmit one or more signals 108 that instruct one or more emission units 110 where to emit focused energy. For example, in some embodiments, a system control unit 112 may transmit one or more signals 108 that instruct one or more emission units 110 to emit focused energy to cause a cavitation induced perforation in one or more mosquito embryos. In some embodiments, a system control unit 112 may transmit one or more signals 108 that instruct one or more emission units 110 to emit focused energy of a certain intensity. In some embodiments, a system control unit 112 may transmit one or more signals 108 that instruct one or more emission units 110 to emit focused energy to cause a cavitation induced perforation in a selected biological object. In some embodiments, a system control unit 112 may transmit one or more signals 108 that instruct one or more emission units 110 to emit focused energy of a selected type. For example, in some embodiments, a system control unit 112 may transmit one or more signals 108 that instruct one or more emission units 110 to emit laser light.

In some embodiments, a system control unit 112 may transmit one or more signals 108 that are received by one or more user interfaces 114. In some embodiments, a system control unit 112 may transmit one or more signals 108 that instruct a user interface 114 to display an image of a biological object that is being transported through a flow channel 120. In some embodiments, a system control unit 112 may transmit one or more signals 108 that instruct a user interface 114 to display information associated with the operational status of one or more flow units 102, fluid control units 104, detection units 106, emission units 110, system control units 112, or any combination thereof.

### User Interface

In some embodiments, system 100 may include one or more user interfaces 114. A user interface 114 may be configured in numerous ways. In some embodiments, a user interface 114 may include one or more mobile device interfaces 238. For example, in some embodiments, a user interface 114 may be configured to receive one or more signals 108 and transmit one or more signals 108 to a cellular telephone or other such mobile device. In some embodiments, a user interface 114 may include one or more user transmitters 242. In some embodiments, a user interface 114 may include one or more user receivers 240. In some embodiments, a user interface 114 may include one or more interface processors 252. In some embodiments, a user interface 114 may include interface memory 250. Accordingly, in some embodiments, a user interface 114 may receive, transmit, and process one or more signals 108. In some embodiments, a user interface 114 may include one or more keyboards 244. In some embodiments, a user interface 114 may include one or more touchpads 246. In some embodiments, a user interface 114 may include one or more user displays 248. In some embodiments, a user interface 114 may include one or more active user displays 248. In some embodiments, a user interface 114 may include one or more passive user displays 248.

In some embodiments, a user interface 114 may be configured to transmit and receive one or more signals 108. For example, in some embodiments, a user interface 114 may receive one or more signals 108 that were transmitted by a detection unit 106 that include one or more images of a biological object that is being transported through a flow channel 120. The one or more images may then be displayed on the user interface 114 such that a user 116 may view the one or more images. A user 116 may then select one or more biological objects that are being transported through a flow channel 120 and cause the user interface 114 to transmit one or more signals 108 that instruct one or more emission units 110 to emit focused energy to cause at least one cavitation induced perforation in the one or more biological objects. In some embodiments, a user 116 may view one or more images of one or more mosquito embryos that are being transported through a flow channel 120. The user 116 may then select a mosquito embryo and determine the posterior portion of the mosquito embryo. The user 116 may then cause the user interface 114 to transmit one or more signals 108 that instruct one or more emission units 110 to emit focused energy to cause at least one cavitation induced perforation in the posterior portion of the mosquito embryo. Accordingly, such protocols may be used with numerous types of biological objects.

FIG. 5 illustrates a top view of system 500. System 500 is shown with an embodiment of a flow unit 102 having a substrate 118 and a flow channel 120 that is fluidly coupled to a flow inlet 124 and to a flow outlet 126. The flow channel 120 includes a series of fiducial markers 122 that are spaced at known positions in the flow channel 120. The direction of flow of a carrier fluid through the flow channel 120 is indicated with an arrow and is from the right to the left. Two mosquito embryos 502 are within the flow channel 120. The anterior poles of each of the mosquito embryos 502 are shown with a greater cross-sectional diameter than the posterior poles of each of the mosquito embryos 502. Also, the posterior poles of the mosquito embryos 502 are illustrated with a darker color than each of the anterior poles of the mosquito embryos 502. Accordingly, the mosquito embryo 502 illustrated on the left is shown as being transported through the flow channel 120 in a posterior-anterior orientation and the mosquito embryo 502 illustrated on the right is shown as being transported through the flow channel 120 in an anterior-posterior orientation.

FIG. 6 illustrates a top view of system 600. System 600 is shown with an embodiment of a flow unit 102 having a substrate 118 and a flow channel 120 that is fluidly coupled to a flow inlet 124 and to a flow outlet 126. The flow channel 120 includes a calibrated grid pattern 602 that has spacings at known positions in the flow channel 120. The direction of flow of a carrier fluid through the flow channel 120 is indicated with an arrow and is from the right to the left. Two mosquito embryos 502 are illustrated in FIG. 6. The anterior poles of each of the mosquito embryos 502 are shown with a greater cross-sectional diameter than the posterior poles of each of the mosquito embryos 502. Also, the posterior poles of the mosquito embryos 502 are illustrated with a darker color than each of the anterior poles of the mosquito embryos 502. Accordingly, the mosquito embryo 502 illustrated on the left is shown as being transported through the flow channel 120 in a posterior-anterior orientation and the mosquito embryo 502 illustrated on the right is shown as being transported through the flow channel 120 in an anterior-posterior orientation.

FIG. 7 illustrates a top view of system 700. System 700 is shown with an embodiment of a flow unit 102 having a substrate 118 and multiple flow channels 120 that are fluidly coupled to multiple flow inlets 124 and to multiple flow outlets 126. Two calibrated grid patterns 602 that are associated with flow channels 120 are illustrated. FIG. 7 also illustrates multiple sorting actuators 132 that are configured to obstruct a flow channel 120 when activated. Sorting actuators 132 are illustrated in an active conformation to obstruct a flow channel 120 and are also illustrated in an inactivated conformation to allow unobstructed flow through a flow channel 120. Numerous mosquito embryos 502 are illustrated. The anterior poles of each of the mosquito embryos 502 are shown with a greater cross-sectional diameter than the posterior poles of each of the mosquito embryos 502. Also, the posterior poles of the mosquito embryos 502 are illustrated with a darker color than each of the anterior poles of the mosquito embryos 502. Accordingly, FIG. 7 illustrates mosquito embryos 502 being initially sorted according to their anterior-posterior orientation as they are transported through the flow channel 120 with posterior-anterior mosquito embryos 502 being directed to the lower flow channel 120 and the anterior-posterior mosquito embryos 502 being directed to the upper flow channel 120. Also illustrated is sorting according to a detectable characteristic of the mosquito embryos 502. For example, in some embodiments, a detectable tag may be included within a carrier fluid that can enter into a mosquito embryo 502 through a cavitation induced perforation. In FIG. 7, mosquito embryos 502 that include a detectable tag after undergoing cavitation induced perforation are illustrated as being darker in color when compared to mosquito embryos 502 that do not include the detectable tag. Accordingly, FIG. 7 illustrates mosquito embryos 502 that include a detectable tag being sorted from mosquito embryos 502 that do not include the detectable tag.

FIG. 8 illustrates a top view of system 800. System 800 is shown with an embodiment of a flow unit 102 having a substrate 118 and a flow channel 120 that is fluidly coupled to a flow inlet 124 and a flow outlet 126. The direction of carrier fluid flow is indicated with an arrow and is from the right to the left. Two mosquito embryos 502 are within the flow channel 120. FIG. 8 illustrates a series of electrodes 802 that are operably coupled to a series of leads 804 and to the flow channel 120. In some embodiments, such electrodes 802 may be included as part of an electrical conductance detector 174. In some embodiments, such electrodes may be included as part of an electrical resistance detector 176. In some embodiments, such electrodes may be included as part of a capacitance detector 254. In some embodiments, such electrodes 802 may be included as part of a microwave generator 222 that is configured to direct microwave energy into the flow channel 120 to produce cavitation (see e.g., Rassaei et al, Discharge cavitation during microwave electrochemistry at micrometre-sized electrodes, Chem. Commun., 46(5): 812-814 (2010)).

FIG. 9 illustrates a top view of system 900. System 900 is shown with an embodiment of a flow unit 102 having a substrate 118 and a flow channel 120 that is fluidly coupled to a flow inlet 124 and a flow outlet 126. The direction of carrier fluid flow is indicated with an arrow and is from the right to the left. Three mosquito embryos 502 are within the flow channel 120. FIG. 9 illustrates a first series of optical fibers 902 that are operably coupled to one side of the flow channel 120 and a second series of optical fibers 904 that are operably coupled to the opposite side of the flow channel 120 at know positions. The first series of optical fibers 902 and the second series of optical fibers 904 are illustrated as being paired such that light emitted from an optical fiber 902 belonging to the first series will be received by the paired optical fiber belonging to the second series 904 on the opposite side of the flow channel 120 (see e.g., Schafer et al., Microfluidic cell counter with embedded optical fibers fabricated by femtosecond laser ablation and anionic bonding, Optics Express, 17(8): 6068-6073 (2009)). Also illustrated is a light source 162 that directs light 906 into a series of collimators 908 that are operably coupled to the first series 902 of optical fibers. In some embodiments, such a light source 162 may be a laser. In some embodiments, multiple light sources 162 may emit light 906 into one or more optical fibers 902. The second series of optical fibers 904 are illustrated that receive light emitted from the first series of optical fibers 902. Optical fibers 904 that are members of the second series are illustrated as being operably coupled to a collimator 908. Light 910 emitted from a collimator 908 of the second series of optical fibers 904 may be detected by one or more photodiodes 166. Accordingly, in some embodiments, system 900 may be used to determine the position of one or more biological objects that are transported through the flow channel 120 by detecting light scattering as a biological object blocks the transmission of light from one paired optical fiber 902 to the other. System 900 may be used in conjunction with numerous types of detection methods. In some embodiments, system 900 may be configured for use with numerous types of spectroscopy. For example, in some embodiments, system 900 may be used in conjunction with ultraviolet/visible light spectroscopy.

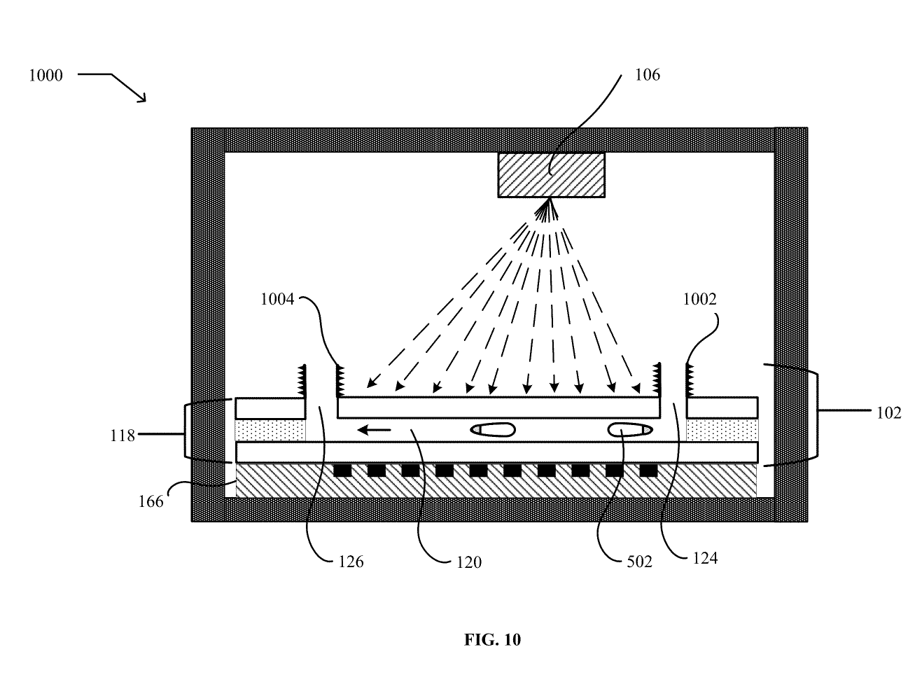

FIG. 10 illustrates a side view of system 1000. System 1000 is shown with an embodiment of a flow unit 102 having a substrate 118 and a flow channel 120 that is fluidly coupled to a flow inlet 124 and a flow outlet 126. Two mosquito embryos 502 are included within the flow channel 120. An inlet connector 1002 and an outlet connector 1004 are operably coupled with the flow inlet 124 and the flow output 126 respectively. The substrate 118 in this embodiment has a quartz bottom layer, a middle layer that includes a flow channel 120, and a quartz top layer. In some embodiments, light may pass through the quartz top and bottom layers and through the flow channel 120 of the flow unit 102. The flow unit 102 is positioned over a photodiode 166 array. A detection unit 106 is positioned over the flow unit 102 and is configured to emit light that passes through the flow unit 102 and is detected by the photodiode 166 array. Accordingly, in some embodiments, system 100 may be used to determine the position of one or more biological objects that are being transported through the flow channel 120 by detecting light scattering that occurs as the one or more biological objects are transported though the flow channel 120. In some embodiments, system 1000 may be configured for use with numerous types of spectroscopy. For example, in some embodiments, system 1000 may be used in conjunction with ultraviolet/visible light spectroscopy.

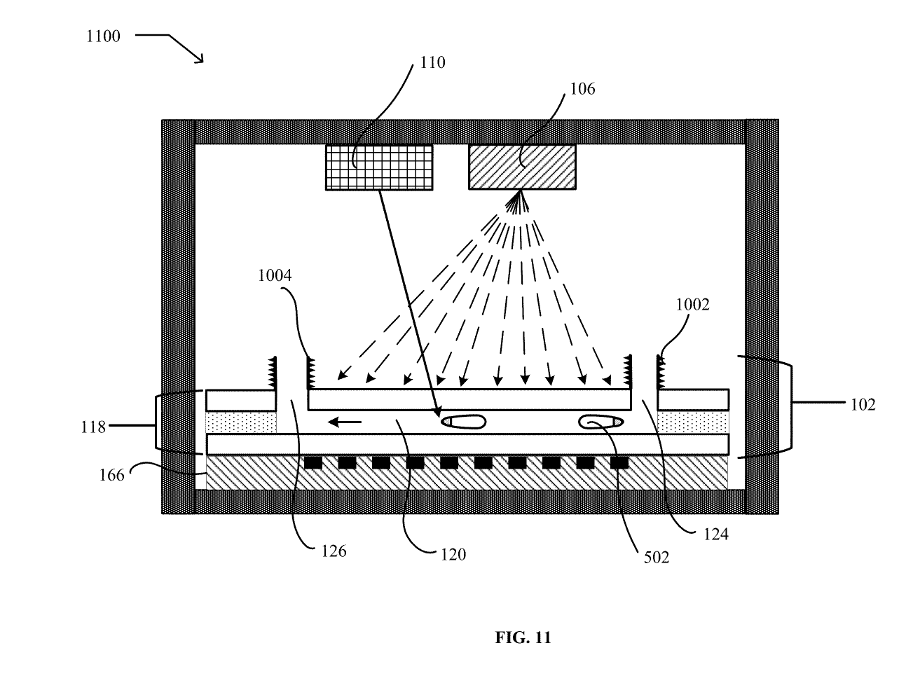

FIG. 11 illustrates a side view of system 1100. System 1100 is shown with an embodiment of a flow unit 102 having a substrate 118 and a flow channel 120 that is fluidly coupled to a flow inlet 124 and a flow outlet 126. An inlet connector 1002 and an outlet connector 1004 are operably coupled with the flow inlet 124 and the flow outlet 126 respectively. Two mosquito embryos 502 are included within the flow channel 120. The substrate 118 in this embodiment has a quartz bottom layer, a middle layer that includes a flow channel 120, and a quartz top layer. The flow unit 102 is positioned over a photodiode 166 array detector. A detection unit 106 is positioned over the flow unit 102 and is configured to emit light that passes through the flow unit 102 and is detected by the photodiode 166 array. Accordingly, in some embodiments, system 100 may be used to determine the position of one or more biological objects that are being transported through the flow channel 120 by detecting light scattering that occurs as the one or more biological objects are transported though the flow channel 120. System 1100 also includes an emission unit 110 that directs focused energy into the flow channel 120 to cause one or more cavitation induced perforations in one or more biological objects that are transported through the flow channel 120. The emission unit 110 is shown directing laser light to the posterior pole of a mosquito embryo 502.

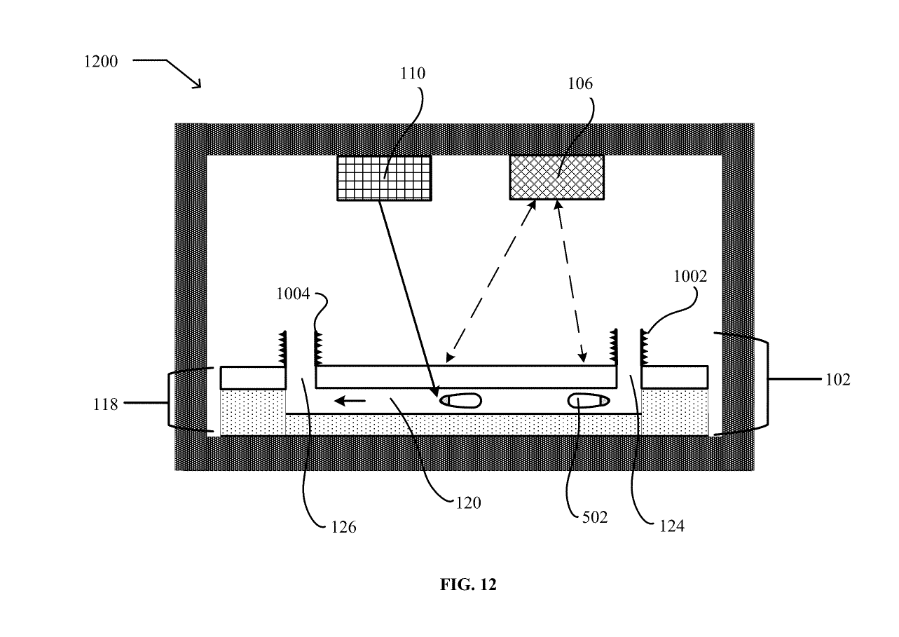

FIG. 12 illustrates a side view of system 1200. System 1200 is shown with an embodiment of a flow unit 102 having a substrate 118 and a flow channel 120 that is fluidly coupled to a flow inlet 124 and a flow outlet 126. An inlet connector 1002 and an outlet connector 1004 are operably coupled with the flow inlet 124 and the flow outlet 126 respectively. Two mosquito embryos 502 are included within the flow channel 120. The substrate 118 in this embodiment has a bottom layer and a quartz top layer. A detection unit 106 is positioned over the flow unit 102 and is configured acquire images of one or more biological objects as they are transported through the flow channel 120. System 1200 also includes an emission unit 110 that directs focused energy into the flow channel 120 to cause one or more cavitation induced perforations in one or more biological objects that are transported through the flow channel 120. The emission unit 110 is shown directing laser light to the posterior pole of a mosquito embryo 502.

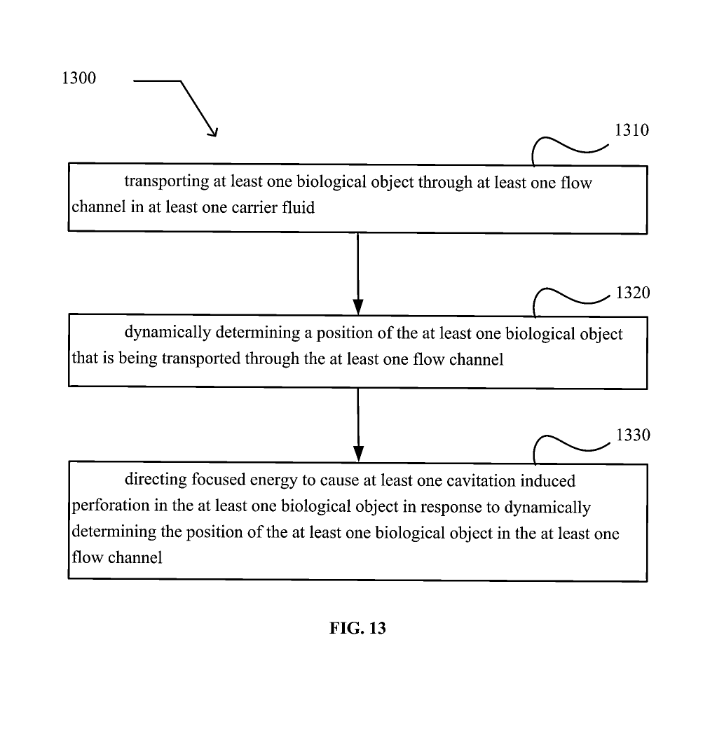

FIG. 13 illustrates operational flow 1300 that includes operation 1310 that includes transporting at least one biological object through at least one flow channel 120 in at least one carrier fluid, operation 1320 that includes dynamically determining a position of the at least one biological object that is being transported through the at least one flow channel 120, and operation 1330 that includes directing focused energy to cause at least one cavitation induced perforation in the at least one biological object in response to dynamically determining the position of the at least one biological object in the at least one flow channel 120.

In FIG. 13 and in the following description that includes various examples of operations used during performance of the method, discussion and explanation may be provided with respect to any one or combination of the above-described examples, and/or with respect to other examples and contexts. However, it should be understood that the operations may be executed in a number of other environments and contexts, and/or modified versions of the figures. Also, although the various operations are presented in the sequence(s) illustrated, it should be understood that the various operations may be performed in other orders than those which are illustrated, or may be performed concurrently.

Operation 1310 includes transporting at least one biological object through at least one flow channel 120 in at least one carrier fluid. In some embodiments, a biological object may be transported through a flow channel 120 that is included within a flow unit 102. In some embodiments, a fluid control unit 104 may cause one or more carrier fluids to flow through the at least one flow channel 120. In some embodiments, a fluid control unit 104 may receive one or more signals 108 that control the operation of the fluid control unit 104. Numerous types of biological objects may be transported. Examples of such biological objects include, but are not limited to, bacteria, cells, human cells, non-human cells, plant cells, eggs, avian eggs, non-human embryos, non-human mammalian embryos, insect embryos, mosquito embryos, and the like. A biological object may be transported in numerous types of carrier fluids and combinations of carrier fluids. Examples of such carrier fluids include, but are not limited to, hydrophilic carrier fluids, hydrophobic carrier fluids, aqueous carrier fluids, buffers, solvents, and the like.

Operation 1320 includes dynamically determining a position of the at least one biological object that is being transported through the at least one flow channel 120. In some embodiments, one or more detection units 106 may dynamically determine a position of at least one biological object that is being transported through at least one flow channel 120. In some embodiments, a detection unit 106 may determine the position of at least one biological object that is being transported through at least one flow channel 120. In some embodiments, a detection unit 106 may determine the velocity of at least one biological object that is being transported through at least one flow channel 120. In some embodiments, a detection unit 106 may determine the position and velocity of at least one biological object that is being transported through at least one flow channel 120. In some embodiments, a detection unit 106 may predict one or more future positions of at least one biological object that is being transported through at least one flow channel 120 at one or more future times. In some embodiments, a detection unit 106 may continuously determine the position of at least one biological object that is being transported through at least one flow channel 120. In some embodiments, a detection unit 106 may continuously determine the velocity of at least one biological object that is being transported through at least one flow channel 120. In some embodiments, a detection unit 106 may continuously determine the position and velocity of at least one biological object that is being transported through at least one flow channel 120. In some embodiments, a detection unit 106 may intermittently determine the position of at least one biological object that is being transported through at least one flow channel 120. In some embodiments, a detection unit 106 may intermittently determine the velocity of at least one biological object that is being transported through at least one flow channel 120. In some embodiments, a detection unit 106 may intermittently determine the position and velocity of at least one biological object that is being transported through at least one flow channel 120. A detection unit 106 may be configured in numerous ways to dynamically determine a position of at least one biological object that is being transported through at least one flow channel 120. For example, in some embodiments, a detection unit 106 may be configured to acquire one or more images of a biological object that is being transported through a flow channel 120. In some embodiments, a detection unit 106 may dynamically determine a position of at least one biological object that is being transported through at least one flow channel 120 through the use of spectroscopy. In some embodiments, a detection unit 106 may dynamically determine a position of at least one biological object that is being transported through at least one flow channel 120 through detection of electrical conductance, resistance, and/or capacitance.

Operation 1330 includes directing focused energy to cause at least one cavitation induced perforation in at least one biological object in response to dynamically determining the position of at least one biological object in at least one flow channel 120. In some embodiments, one or more emission units 110 may direct focused energy to cause at least one cavitation induced perforation in at least one biological object in response to dynamically determining the position of at least one biological object in at least one flow channel 120. In some embodiments, one or more emission units 110 may direct focused energy at one or more biological objects that are being transported through one or more flow channels 120 in one or more carrier fluids. For example, in some embodiments, an emission unit 110 may dynamically track the movement of a biological object as it is transported through a flow channel 120. Accordingly, in some embodiments, an emission unit 110 may track the movement of a biological object and direct focused energy to cause at least one cavitation induced perforation in the biological object while it is moving. In some embodiments, an emission unit 110 may direct focused energy at one or more positions in a flow channel 120 where a biological object is predicted to be at one or more times in the future. For example, in some embodiments, an emission unit 110 may direct a pulse of focused energy at a position in an flow channel 120 at a time when a biological object is predicted to be at the position in the flow channel 120. Accordingly, in some embodiments, an emission unit 110 may direct focused energy at a time and position in a flow channel 120 based on the predicted position of a biological object in the flow channel 120 at a time in the future. An emission unit 110 may direct numerous types of focused energy to cause a cavitation induced perforation in a one biological object. Examples of such focused energy include, but are not limited to, light energy, radiofrequency energy, ultrasound energy, microwave energy, and the like. For example, in some embodiments, an emission unit 110 may direct laser light to cause a cavitation induced perforation in a one biological object. In some embodiments, an emission unit 110 may direct laser light to cause a cavitation induced perforation in a mosquito embryo. In some embodiments, an emission unit 110 may direct laser light to cause a cavitation induced perforation in the posterior pole of a mosquito embryo.

In some embodiments, operation 1310 includes transporting at least one bacterium through at least one flow channel 120 in at least one carrier fluid (not shown). In some embodiments, a bacterium may be transported through a flow channel 120 that is included in a flow unit 102. Numerous types of bacteria may be transported through one or more flow channels 120. Examples of such bacteria include, but are not limited to, Gram-negative bacteria, Gram-positive bacteria, pathogenic bacteria, and the like. Additional examples of such bacteria include, but are not limited to, Chlamydia, Green nonsulfur bacteria, Actinobacteria, Planctomycetes, Spirochaetes, Fusobacteria, Cyanobacteria, Thromophilic bacteria, Sulfur-reducing bacteria, Acidobacteria, Photeobacteria, and the like.

In some embodiments, operation 1310 includes transporting at least one cell through at least one flow channel 120 in at least one carrier fluid (not shown). In some embodiments, a cell may be transported through a flow channel 120 that is included in a flow unit 102. Numerous types of cells may be transported through one or more flow channels 120. Examples of such cells include, but are not limited to, plant cells, animal cells, human cells, non-human cells, prokaryotic cells, eukaryotic cells, and the like.

In some embodiments, operation 1310 includes transporting at least one human cell through at least one flow channel 120 in at least one carrier fluid (not shown). In some embodiments, a human cell may be transported through a flow channel 120 that is included in a flow unit 102. Numerous types of human cells may be transported through one or more flow channels 120. Examples of such human cells include, but are not limited to, blood cells, connective tissue cells, nervous tissue cells, receptor cells, and the like. Additional examples of human cells include, but are not limited adipocytes, Alzheimer type II astrocyte, ameloblasts, astrocytes, B-cells, basophil granulocytes, bistratified cells, Boettcher cell, cardiac muscle cells, CD4+ T cells, cementoblasts, cerebellum granule cells, cholangiocytes, cholecystocytes, chromaffin cells, cigar cells, clara cells, cone cells, corticotropic cells, cytotoxic T cells, dendritic cells, enterochromaffin cells, enterochromaffin-like cells, eosinophil granulocytes, extraglomerular mesangial cells, faggot cells, follicular cells, foveolar cells, gastric chief cells, goblet cells, gonadotropic cells, hepatocytes, hypersegmented neutrophils, intraglomerular mesangial cells, juxtaglomerular cells, keratinocytes, kidney proximal tubule brush border cells, Kupffer cells, Leydig cells, macrophages, macula densa cells, magnocellular neurosecretory cells, mast cells, megakaryocytes, melanocytes, microfold cells, microglias, midget cells, monocytes, natural killer cells, natural killer T-cells, glitter cells, neutrophils, olfactory bulb mitral cells, osteoblasts, osteoclasts, osteocytes, oxyphil cells, paneth cells, parafollicular cells, parasol cells, parathyroid chief cells, parietal cells, pericytes, platelets, pneumocytes, podocytes, prolactin cells, red blood cells, regulatory T-cells, reticulocytes, retina amacrine cells, retina bipolar cells, retina horizontal cells, retinal ganglion cells, rod cells, Sertoli cells, somatotropic cells, spermatozoon, stellate cells, sustentacular cells, T-cells, T-helper cells, target cells, tlocytes, thrombocytes, thyrotropic cells, white blood cells, and the like.

In some embodiments, operation 1310 includes transporting at least one HeLa cell through at least one flow channel 120 in at least one carrier fluid (not shown). In some embodiments, a HeLa cell may be transported through a flow channel 120 that is included in a flow unit 102.

In some embodiments, operation 1310 includes transporting at least one non-human cell through at least one flow channel 120 in at least one carrier fluid (not shown). In some embodiments, a non-human cell may be transported through a flow channel 120 that is included in a flow unit 102. Numerous types of non-human cells may be transported through one or more flow channels 120. Examples of such non-human cells include, but are not limited to, plant cells, animal cells, fungal cells, single-celled organisms, and the like.

In some embodiments, operation 1310 includes transporting at least one plant cell through at least one flow channel 120 in at least one carrier fluid (not shown). In some embodiments, a plant cell may be transported through a flow channel 120 that is included in a flow unit 102. Numerous types of plant cells may be transported through one or more flow channels 120. Examples of such plant cells include, but are not limited to, parenchyma cells, collenchyma cells, sclerenchyma cells, meristematic cells, xylem cells, epidermal cells, and the like. In some embodiments, plant cells may be from crop plants. Examples of such plants include, but are not limited to, maize, rice, wheat, barley, soy beans, beans, and the like.

In some embodiments, operation 1310 includes transporting at least one Chinese hamster ovary cell through at least one flow channel 120 in at least one carrier fluid (not shown). In some embodiments, a Chinese hamster ovary cell may be transported through a flow channel 120 that is included in a flow unit 102.

In some embodiments, operation 1310 includes transporting at least one egg through the at least one flow channel 120 in the at least one carrier fluid (not shown). In some embodiments, an egg may be transported through a flow channel 120 that is included in a flow unit 102. Numerous types of eggs may be transported through one or more flow channels 120. Examples of such eggs include, but are not limited to, mammalian eggs, non-mammalian eggs, avian eggs, insect eggs, amphibian eggs, and the like.

In some embodiments, operation 1310 includes transporting at least one avian egg through the at least one flow channel 120 in the at least one carrier fluid (not shown). In some embodiments, an avian egg may be transported through a flow channel 120 that is included in a flow unit 102. Numerous types of avian eggs may be transported through one or more flow channels 120. Examples of such avian eggs include, but are not limited to, chicken eggs, turkey eggs, partridge eggs, and the like.

In some embodiments, operation 1310 includes transporting at least one non-human embryo through at least one flow channel in at least one carrier fluid (not shown). In some embodiments, a non-human embryo may be transported through a flow channel 120 that is included in a flow unit 102. Numerous types of non-human embryos may be transported through one or more flow channels 120. Examples of such non-human embryos include, but are not limited to, non-human mammalian embryos, insect embryos, amphibian embryos, plant embryos, fish embryos, and the like. Additional examples of such non-human embryos include, but are not limited to, bovine embryos, porcine embryos, goat embryos, sheep embryos, canine embryos, feline embryos, and the like.

In some embodiments, operation 1310 includes transporting at least one non-human mammalian embryo through at least one flow channel 120 in at least one carrier fluid (not shown). In some embodiments, a non-human mammalian embryo may be transported through a flow channel 120 that is included in a flow unit 102. Numerous types of non-human mammalian embryos may be transported through one or more flow channels 120. Examples of such non-human mammalian embryos include, but are not limited to, bovine embryos, porcine embryos, goat embryos, sheep embryos, canine embryos, feline embryos, and the like.

In some embodiments, operation 1310 includes transporting at least one insect embryo through at least one flow channel 120 in at least one carrier fluid (not shown). In some embodiments, an insect embryo may be transported through a flow channel 120 that is included in a flow unit 102. Numerous types of insect embryos may be transported through one or more flow channels 120. Examples of such insect embryos include, but are not limited to, mosquito embryos, tick embryos, fly embryos, wasp embryos, and the like.

In some embodiments, operation 1310 includes transporting at least one mosquito embryo through at least one flow channel 120 in at least one carrier fluid (not shown). In some embodiments, a mosquito embryo may be transported through a flow channel 120 that is included in a flow unit 102. Numerous types of mosquito embryos may be transported through one or more flow channels 120. For example, mosquito embryos from Aedes aegypti, Anopheles stephensi, Ochlerotatus notoscriptus, Anopheles albimanus, and the like may be transported through a flow channel 120.

In some embodiments, operation 1310 includes transporting at least one biological object through at least one flow channel 120 though use of one or more pressure pumps 150, volumetric pumps 152, piston pumps 154, peristaltic pumps 156, syringe pumps 158, or combinations thereof (not shown). In some embodiments, a flow control unit may include one or more such pumps 148. In some embodiments, a fluid control unit 104 may receive one or more signals 108 that direct the operation of one or more pumps 148.

In some embodiments, operation 1310 includes transporting at least one biological object through at least one flow channel 120 in at least one buffer (not shown). In some embodiments, a biological object may be transported through a flow channel 120 in a flow unit 102 in at least one buffer. Numerous types of buffers may be used. Examples of such buffers include, but are not limited to, TAPS (3-{[tris(hydroxymethyl)methyl]amino}propanesulfonic acid), TRIS (tris(hydroxymethyl)methylamine), HEPES (4-2-hydroxyethyl-1-piperazineethanesulfonic acid), MOPS (3-(N-morpholino)propanesulfonic acid), and the like.

In some embodiments, operation 1310 includes transporting at least one biological object through at least one flow channel 120 in at least one hydrophobic carrier fluid (not shown). In some embodiments, a biological object may be transported through a flow channel 120 in a flow unit 102 in at least one hydrophobic carrier fluid. Numerous types of hydrophobic carrier fluids may be used. Examples of such hydrophobic carrier fluids include, but are not limited to, pentane, cyclopentane hexane, cyclohexane, benzene, toluene, chloroform, diethyl ether, and the like.

In some embodiments, operation 1310 includes transporting at least one biological object through at least one flow channel 120 in at least one hydrophilic carrier fluid (not shown). In some embodiments, a biological object may be transported through a flow channel 120 in a flow unit 102 in at least one hydrophilic carrier fluid. Numerous types of hydrophilic carrier fluids may be used. Examples of such hydrophilic carrier fluids include, but are not limited to, water, methanol, ethanol, and the like.

In some embodiments, operation 1310 includes transporting at least one biological object through at least one flow channel 120 that has a width and a depth that are greater than the cross-sectional diameter of the at least one biological object and less than the length of the at least one biological object (not shown). In some embodiments, a biological object may be transported through a flow unit 102 that includes a flow channel 120 having a width and a depth that are greater than the cross-sectional diameter of the biological object and less than the length of the biological object.

In some embodiments, operation 1310 includes transporting at least one mosquito embryo through at least one flow channel 120 that has a width and a depth that are greater than the cross-sectional diameter of the mosquito embryo and less than the length of the mosquito embryo (not shown). In some embodiments, a mosquito embryo may be transported through a flow unit 102 that includes a flow channel 120 having a width and a depth that are greater than the cross-sectional diameter of the mosquito embryo and less than the length of the mosquito embryo. For example, in some embodiments, a mosquito embryo may be transported through a flow channel 120 having a width and a depth that are between about 0.4 millimeter and about 0.2 millimeter.

In some embodiments, operation 1310 includes transporting at least one biological object through at least one flow channel 120 that has a width and a depth that are between about 10 centimeters and about 1 centimeter, between about 5 centimeters and about 1 centimeter, between about 1000 millimeters and about 10 millimeters, between about 10 millimeters and about 1 millimeter, between about 1 millimeter and about 0.1 millimeter, between about 0.4 millimeter and about 0.2 millimeter, between about 200 micrometers and about 50 micrometers, or between about 50 micrometers and about 5 micrometers (not shown). In some embodiments, a biological object may be transported through a flow unit 102 that includes a flow channel 120 having a width and a depth that are between about 10 centimeters and about 1 centimeter, between about 5 centimeters and about 1 centimeter, between about 1000 millimeters and about 10 millimeters, between about 10 millimeters and about 1 millimeter, between about 1 millimeter and about 0.1 millimeter, between about 0.4 millimeter and about 0.2 millimeter, between about 200 micrometers and about 50 micrometers, or between about 50 micrometers and about 5 micrometers.

In some embodiments, operation 1310 includes transporting at least one biological object through at least one flow channel 120 that has a width and a depth that are about 0.3 millimeter (not shown). In some embodiments, a biological object may be transported through a flow unit 102 that includes a flow channel 120 having a width and a depth that are about 0.3 millimeter.

In some embodiments, operation 1310 includes actively positioning a biological object within a flow channel 120 (not shown). In some embodiments, a biological object may be actively positioned within a flow channel 120 that is included within a flow unit 102. For example, in some embodiments, a biological object may be actively positioned within a flow channel 120 by controlling the operation of one or more pumps 148 that control flow of a carrier fluid through the flow channel 120. In some embodiments, a detection unit 106 may detect the position of a biological object in a flow channel 120 and then transmit one or more signals 108 that are received by a fluid control unit 104 that controls the operation of one or more pumps 148 in response to the one or more signals 108.

In some embodiments, operation 1310 includes actively positioning a biological object within a flow channel 120 by controlling flow of a carrier fluid in the flow channel 120 (not shown). In some embodiments, a biological object may be actively positioned within a flow channel 120 that is included within a flow unit 102 by controlling flow of a carrier fluid in the flow channel 120. For example, in some embodiments, a biological object may be actively positioned within a flow channel 120 by controlling the operation of one or more pumps 148 that control flow of a carrier fluid through the flow channel 120. In some embodiments, a detection unit 106 may detect the position of a biological object in a flow channel 120 and then transmit one or more signals 108 that are received by a fluid control unit 104 that controls the operation of one or more pumps 148 in response to the one or more signals 108.

In some embodiments, operation 1310 includes actively positioning a biological object within a flow channel 120 by reversing flown of a carrier fluid in the flow channel 120 (not shown). In some embodiments, a biological object may be actively positioned within a flow channel 120 that is included within a flow unit 102 by reversing flow of a carrier fluid in the flow channel 120. For example, in some embodiments, a biological object may be actively positioned within a flow channel 120 by reversing one or more pumps 148 that control flow of a carrier fluid through the flow channel 120. In some embodiments, a detection unit 106 may detect the position of a biological object in a flow channel 120 and then transmit one or more signals 108 that are received by a fluid control unit 104 that cause the operation of one or more pumps 148 to be reversed in response to the one or more signals 108.

In some embodiments, operation 1310 includes actively positioning a biological object within a flow channel 120 by controlling flow of a carrier fluid in the flow channel 120 in response to dynamically determining the position of the biological object (not shown). In some embodiments, a biological object may be actively positioned within a flow channel 120 that is included within a flow unit 102 in response to dynamically determining the position of the biological object in the flow channel 120. For example, in some embodiments, a detection unit 106 may determine the movement of a biological object being transported through a flow channel 120 and transmit one or more signals 108 that are received by a fluid control unit 104 that controls the operation of one or more pumps 148 in response to the one or more signals 108.

In some embodiments, operation 1310 includes transporting the at least one biological object in at least one carrier fluid that includes at least one article that can enter into the at least one biological object through the at least one cavitation induced perforation (not shown). In some embodiments, a carrier fluid may include an article that can enter into a biological object through a cavitation induced perforation. Numerous types of articles may be included in a carrier fluid. Examples of such articles include, but are not limited to, artificial nucleic acid constructs, bacteria, peptides, peptide constructs, polypeptides, antibodies, drugs, tags, antigens, and the like.

In some embodiments, operation 1310 includes transporting the at least one biological object in at least one carrier fluid that includes at least one article that can enter into the at least one biological object through the at least one cavitation induced perforation, wherein the at least one biological object is a bacterium, a cell, a human cell, a non-human cell, a plant cell, an egg, an avian egg, a non-human embryo, a non-human mammalian embryo, a fish embryo, or an insect embryo (not shown). In some embodiments, a carrier fluid may include an article that can enter into a bacterium, a cell, a human cell, a non-human cell, a plant cell, an egg, an avian egg, a non-human embryo, a non-human mammalian embryo, a fish embryo, or an insect embryo through a cavitation induced perforation. Numerous types of articles may enter into a bacterium, a cell, a human cell, a non-human cell, a plant cell, an egg, an avian egg, a non-human embryo, a non-human mammalian embryo, a fish embryo, or an insect embryo. Examples of such articles include, but are not limited to, artificial nucleic acid constructs, peptides, peptide constructs, polypeptides, antibodies, drugs, tags, antigens, and the like.

In some embodiments, operation 1310 includes transporting at least one mosquito embryo in at least one carrier fluid that includes at least one article that can enter into the mosquito embryo through the at least one cavitation induced perforation (not shown). In some embodiments, a carrier fluid may include an article that can enter into a mosquito embryo through at least one cavitation induced perforation. Examples of such articles include, but are not limited to, artificial nucleic acid constructs, bacteria, peptides, peptide constructs, polypeptides, antibodies, drugs, tags, antigens, and the like.

In some embodiments, operation 1310 includes transporting at least one biological object in at least one carrier fluid that includes at least one artificial nucleic acid construct that can enter into the at least one biological object through the at least one cavitation induced perforation (not shown). In some embodiments, a carrier fluid may include an artificial nucleic acid construct that can enter into a biological object through a cavitation induced perforation. Numerous types of artificial nucleic acid constructs may be included in a carrier fluid. Examples of such artificial nucleic acid constructs include, but are not limited to, plasmids, artificial chromosomes, yeast artificial chromosomes, and the like. In some embodiments, artificial nucleic acid constructs may be constructed that will be expressed within a biological object that they enter. For example, in some embodiments, an artificial nucleic acid construct may encode one or more proteins that are expressed within a biological object. Examples of such proteins include, but are not limited to, marker proteins (e.g., green fluorescent protein), enzymes, antigens, and the like. In some embodiments, an artificial nucleic acid construct may encode a functional nucleic acid. Examples of such nucleic acids include, but are not limited to, an antisense message, a ribozyme, a transfer ribonucleic acid, and the like. In some embodiments, an artificial nucleic acid construct may include one or more transposable elements. Accordingly, in some embodiments, an artificial nucleic acid construct may be used to transform one or more biological objects. In some embodiments, an artificial nucleic acid construct may be used to create a transgenic biological object. In some embodiments, an artificial nucleic acid construct may be used for gene replacement in a biological object. In some embodiments, an artificial nucleic acid construct may be used to create a knock-in mutation in a biological object. In some embodiments, an artificial nucleic acid construct may be used to create a knock-out mutation in a biological object. Accordingly, artificial nucleic acid constructs may be configured in numerous ways.

In some embodiments, operation 1310 includes transporting at least one biological object in at least one carrier fluid that includes at least one artificial nucleic acid construct that encodes a marker that can enter into the at least one biological object through the at least one cavitation induced perforation (not shown). In some embodiments, a carrier fluid may include an artificial nucleic acid construct that encodes a marker that can enter into a biological object through a cavitation induced perforation. Artificial nucleic acid constructs may encode numerous types of markers that may be expressed within a biological object that they enter. In some embodiments, a marker may be a fluorescent protein. Examples of such fluorescent proteins include, but are not limited to, green fluorescent protein, red fluorescent protein, yellow fluorescent protein, and the like. In some embodiments, an artificial nucleic acid construct may encode a marker protein that inserts into the membrane of a biological object and serves to identify the biological object. In some embodiments, such marker proteins may be recognized by an antibody.

In some embodiments, operation 1310 includes transporting at least one biological object in at least one carrier fluid that includes at least one artificial nucleic acid construct that includes a transposable element that can enter into the at least one biological object through the at least one cavitation induced perforation (not shown). In some embodiments, a carrier fluid may include an artificial nucleic acid construct that includes a transposable element that can enter into a biological object through a cavitation induced perforation. An artificial nucleic acid construct may include numerous types of transposable elements. Examples of such transposable elements include, but are not limited to, Hermes, Mariner, Minos, PiggyBac, P elements, SINE, and the like.

In some embodiments, operation 1310 includes transporting at least one biological object in at least one carrier fluid that includes at least one peptide construct that can enter into the at least one biological object through the at least one cavitation induced perforation (not shown). In some embodiments, a carrier fluid may include a peptide construct that can enter into a biological object through a cavitation induced perforation. Numerous types of peptide constructs may be included within a carrier fluid. Examples of such peptide constructs include, but are not limited to, antibodies, antigens, marker proteins, enzymes, and the like.

In some embodiments, operation 1310 includes transporting at least one biological object in at least one carrier fluid that includes at least one antigen that can enter into the at least one biological object through the at least one cavitation induced perforation (not shown). In some embodiments, a carrier fluid may include an antigen that can enter into a biological object through a cavitation induced perforation. Numerous types of antigens may be included within a carrier fluid. Examples of such antigens include, but are not limited to, maker proteins, allergens, superantigens, T-dependent antigens, immunodominant antigens, toxins, and the like.

In some embodiments, operation 1310 includes transporting at least one biological object in at least one carrier fluid that includes at least one microbe that can enter into the at least one biological object through the at least one cavitation induced perforation (not shown). In some embodiments, a carrier fluid may include a microbe that can enter into a biological object through a cavitation induced perforation. Numerous types of microbes may be included within a carrier fluid. Examples of such microbes include, but are not limited to, bacteria, protozoa, fungi, algae, and the like.

In some embodiments, operation 1310 includes transporting at least one mosquito embryo in at least one carrier fluid that includes at least one Wolbachia bacterium that can enter into the at least one mosquito embryo through the at least one cavitation induced perforation (not shown). In some embodiments, a carrier fluid may include Wolbachia bacteria that can enter into a mosquito embryo through a cavitation induced perforation.

In some embodiments, operation 1310 includes transporting at least one biological object in at least one carrier fluid that includes at least one virus that can enter into the at least one biological object through the at least one cavitation induced perforation (not shown). In some embodiments, a carrier fluid may include a virus that can enter into a biological object through a cavitation induced perforation. Numerous types of viruses may be included within a carrier fluid. Examples of such viruses include, but are not limited to, helical viruses, icosahedral viruses, prolate viruses, enveloped viruses, and the like. Additional examples of viruses include, but are not limited to, double stranded deoxyribonucleic acid viruses, single stranded deoxyribonucleic acid viruses, double stranded ribonucleic acid viruses, single stranded ribonucleic acid viruses, and the like.

In some embodiments, operation 1310 includes transporting at least one biological object in at least one carrier fluid that includes at least one tag that can enter into the at least one biological object through the at least one cavitation induced perforation (not shown). In some embodiments, a carrier fluid may include a tag that can enter into a biological object through a cavitation induced perforation. Numerous types of tags may be included within a carrier fluid. Examples of such tags include, but are not limited to, dyes, quantum dots, ethidium bromide, fluorescein, rhodamine, cyanine, isotope tags, and the like.

In some embodiments, operation 1320 includes determining the velocity of a biological object that is being transported through a flow channel 120 (not shown). In some embodiments, a detection unit 106 may determine the velocity of a biological object that is being transported through a flow channel 120. For example, in some embodiments, a detection unit 106 may determine the position of a biological object in a flow channel 120 at a first time point and determine the position of the biological object at a second time point. The detection unit 106 may then calculate the velocity of the biological object by dividing the distance travelled by the time used to travel the distance.

In some embodiments, operation 1320 includes determining the position of a biological object at a first time point and determining the position of the biological object at another time point and then calculating the velocity of the biological object that is being transported through a flow channel 120 (not shown). In some embodiments, a detection unit 106 may determine the position of a biological object at a first time point and determine the position of the biological object at another time point and then calculate the velocity of the biological object that is being transported through a flow channel 120. For example, the detection unit 106 may calculate the velocity of the biological object by dividing the distance travelled by the time used to travel the distance.

In some embodiments, operation 1320 includes predicting the position of a biological object that is being transported through a flow channel at one or more times in the future (not shown). In some embodiments, a detection unit 106 may predict the position of a biological object that is being transported through a flow channel 120 at one or more times in the future. For example, in some embodiments, a detection unit 106 may determine the velocity of a biological object that is being transported through a flow channel 120 and then use the velocity to predict one or more positions of the biological object in the flow channel 120 at one or more times in the future.

In some embodiments, operation 1320 includes comparing the position of the at least one biological object to a position of at least one fiducial marker 122 associated with the at least one flow channel 120 (not shown). In some embodiments, a detection unit 106 may compare the position of a biological object within a flow channel 120 to a position of a fiducial marker 122 associated with the flow channel 120. For example, in some embodiments, one or more fiducial markers 122 may be associated with a flow channel 120 at known positions along the length of the flow channel 120. Accordingly, in some embodiments, a detection unit 106 may acquire an image of a biological object that is being transported through a flow channel 120 that is associated with one or more fiducial markers 122 and then compare the position of the biological object to the fiducial markers 122 in the image.

In some embodiments, operation 1320 includes determining the position of the at least one biological object in the at least one flow channel 120 through optical detection (not shown). In some embodiments, a detection unit 106 may determine the position of a biological object in a flow channel 120 through use of optical detection. A detection unit 106 may utilize numerous optical detection methods to detect a biological object in a flow channel 120. Examples of such optical detection methods include, but are not limited to, microscopy, spectroscopy, photography, and the like.

In some embodiments, operation 1320 includes determining the position of the at least one biological object in the at least one flow channel 120 through spectroscopic detection (not shown). In some embodiments, a detection unit 106 may determine the position of a biological object in a flow channel 120 through use of spectroscopic detection. A detection unit 106 may utilize numerous spectroscopic detection methods to detect a biological object in a flow channel 120. Examples of such spectroscopic detection methods include, but are not limited to, circular dichroism spectroscopy, ultraviolet/visible light spectroscopy, infrared spectroscopy, fluorescence spectroscopy, and the like.

In some embodiments, operation 1320 includes determining the position of the at least one biological object in the at least one flow channel 120 through fluorescence spectroscopy (not shown). In some embodiments, a detection unit 106 may determine the position of a biological object in a flow channel 120 through use of fluorescence spectroscopy. For example, in some embodiments, a detection unit 106 may detect the intrinsic fluorescence of a biological object to determine the position of the biological object in a flow channel 120. In some embodiments, a detection unit 106 may detect a fluorescent tag that is associated with a biological object to determine the position of the biological object in a flow channel 120. For example, in some embodiments, a detection unit 106 may detect a quantum dot that is associated with a biological object. In some embodiments, a detection unit 106 may detect a fluorescent marker protein that is associated with a biological object to determine the position of the biological object in a flow channel 120. For example, in some embodiments, a detection unit 106 may detect the expression of a fluorescent protein by a biological object that is a cell.

In some embodiments, operation 1320 includes determining the position of the at least one biological object in the at least one flow channel 120 through circular dichroism spectroscopy (not shown). In some embodiments, a detection unit 106 may determine the position of a biological object in a flow channel 120 through use of circular dichroism spectroscopy. For example, in some embodiments, a detection unit 106 may utilize circular dichroism spectroscopy to detect polarization of light that is caused by a biological object.

In some embodiments, operation 1320 includes determining the position of the at least one biological object in the at least one flow channel 120 through detection of electrical conductance (not shown). In some embodiments, a detection unit 106 may determine the position of a biological object in a flow channel 120 through detection of electrical conductance. For example, in some embodiments, a detection unit 106 may measure electrical conductance across a flow channel 120 through use of paired electrodes that are associated with opposite sides of the flow channel 120. Accordingly, the detection unit 106 may detect an alteration in electrical conductance across the flow channel 120 that is caused by passage of a biological object between the paired electrodes that are associated with the flow channel 120.

In some embodiments, operation 1320 includes determining the position of the at least one biological object in the at least one flow channel 120 through detection of electrical resistance (not shown). In some embodiments, a detection unit 106 may determine the position of a biological object in a flow channel 120 through detection of electrical resistance. For example, in some embodiments, a detection unit 106 may measure electrical resistance across a flow channel 120 through use of paired electrodes that are associated with opposite sides of the flow channel 120. Accordingly, the detection unit 106 may detect an alteration in electrical resistance across the flow channel 120 that is caused by passage of a biological object between the paired electrodes that are associated with the flow channel 120.

In some embodiments, operation 1320 includes determining the position of the at least one biological object in the at least one flow channel 120 through detection of capacitance (not shown). In some embodiments, a detection unit 106 may determine the position of a biological object in a flow channel 120 through detection of capacitance. For example, in some embodiments, a detection unit 106 may measure capacitance across a flow channel 120 through use of paired electrodes that are associated with opposite sides of the flow channel 120. Accordingly, the detection unit 106 may detect an alteration in capacitance across the flow channel 120 that is caused by passage of a biological object between the paired electrodes that are associated with the flow channel.

In some embodiments, operation 1320 includes modeling the at least one biological object in the at least one flow channel 120 (not shown). In some embodiments, a detection unit 106 may model a biological object in a flow channel 120. For example, in some embodiments, a detection unit 106 may obtain multiple images of a biological object that is being transported through a flow channel 120 and then assemble the images into a three-dimensional model.

In some embodiments, operation 1320 includes imaging the at least one biological object in the at least one flow channel 120 (not shown). In some embodiments, a detection unit 106 may image a biological object in a flow channel 120. For example, in some embodiments, a detection unit 106 may utilize one or more microscopes 168 to obtain one or more images of a biological object that is being transported through a flow channel 120. In some embodiments, a detection unit 106 may utilize one or more cameras 170 to obtain one or more images of a biological object that is being transported through a flow channel 120. In some embodiments, a detection unit 106 may utilize one or more charge coupled devices to obtain one or more images of a biological object that is being transported through a flow channel 120.

In some embodiments, operation 1320 includes processing at least one image of the at least one biological object to determine an orientation of the at least one biological object in the at least one flow channel 120 (not shown). In some embodiments, a detection unit 106 may process at least one image of a biological object to determine an orientation of the biological object in a flow channel 120. In some embodiments, a detection unit 106 may obtain an image of a biological object and then perform pixel analysis to determine the orientation of a biological object in a flow channel 120. For example, in some embodiments, an image of a mosquito embryo may be obtained and then processed to determine if the mosquito embryo is being transported through a flow channel 120 with the anterior pole of the mosquito embryo in front or with the posterior pole of the mosquito embryo in front. In some embodiments, the posterior pole of the mosquito embryo will have a smaller cross-sectional diameter than the anterior pole of the mosquito embryo.

In some embodiments, operation 1320 includes processing data associated with at least one detectable characteristic of the at least one biological object to determine an orientation of the at least one biological object in the at least one flow channel 120 (not shown). In some embodiments, a detection unit 106 may process data associated with at least one detectable characteristic of a biological object to determine an orientation of the biological object in the one flow channel 120. In some embodiments, a detection unit 106 may obtain an image of a biological object and then perform pixel analysis to determine the orientation of a biological object in a flow channel 120. For example, in some embodiments, an image of a mosquito embryo may be obtained and then processed to determine if the mosquito embryo is being transported through a flow channel 120 with the anterior pole of the mosquito embryo in front or with the posterior pole of the mosquito embryo in front. In some embodiments, the posterior pole of the mosquito embryo will be darker in color than the anterior pole of the mosquito embryo. In some embodiments, a detection unit 106 utilize spectroscopy to determine the orientation of a biological object in a flow channel 120. For example, in some embodiments, a detection unit 106 may utilize spectroscopy to determine which pole of a mosquito embryo is darker and thereby determine the posterior pole of the mosquito embryo.

In some embodiments, operation 1320 includes determining the position of at least one bacterium, cell, human cell, non-human cell, plant cell, egg, avian egg, non-human embryo, non-human mammalian embryo, or insect embryo that is being transported through the at least one flow channel 120 (not shown). In some embodiments, a detection unit 106 may determine the position of a bacterium, a cell, a human cell, a non-human cell, a plant cell, an egg, an avian egg, a non-human embryo, a non-human mammalian embryo, or an insect embryo that is being transported through a flow channel 120. A detection unit 106 may utilize numerous methods to determine the position of a bacterium, a cell, a human cell, a non-human cell, a plant cell, an egg, an avian egg, a non-human embryo, a non-human mammalian embryo, or an insect embryo that is being transported through a flow channel 120. For example, in some embodiments, a detection unit 106 may utilize imaging methods, spectroscopic methods, light scattering methods, and the like to determine the position of a bacterium, a cell, a human cell, a non-human cell, a plant cell, an egg, an avian egg, a non-human embryo, a non-human mammalian embryo, or an insect embryo that is being transported through a flow channel 120.

In some embodiments, operation 1320 includes determining the position of at least one mosquito embryo that is being transported through the at least one flow channel 120 (not shown). In some embodiments, a detection unit 106 may determine the position of a mosquito embryo that is being transported through a flow channel 120. In some embodiments, a detection unit 106 may determine the position of a mosquito embryo by obtaining one or more images of a mosquito embryo in a flow channel 120 and then comparing the image of the mosquito embryo to one or more fiducial markers 122 that are at known positions in the flow channel 120. In some embodiments, a detection unit 106 may determine the position of a mosquito embryo by obtaining one or more images of a mosquito embryo in a flow channel 120 and then comparing the image of the mosquito embryo to a callibrated grid pattern in the flow channel 120 that indicates known positions within the flow channel 120. In some embodiments, a detection unit 106 may determine the position of a mosquito embryo in a flow channel 120 through use of spectroscopic methods. In some embodiments, a detection unit 106 may determine the position of a mosquito embryo in a flow channel 120 through use of light scattering methods. Accordingly, a detection unit 106 may determine the position of a mosquito embryo in a flow channel 120 through use of numerous methods.

In some embodiments, operation 1320 includes determining an orientation of at least one non-human embryo that is being transported through the at least one flow channel 120 (not shown). In some embodiments, a detection unit 106 may determine the position of a non-human embryo that is being transported through a flow channel 120. A detection unit 106 may determine the orientation of numerous types of non-human embryos that are being transported through a flow channel 120. Examples of such non-human embryos include, but are not limited to, non-human mammalian embryos, insect embryos, amphibian embryos, plant embryos, and the like. Additional examples of such non-human embryos include, but are not limited to, bovine embryos, porcine embryos, goat embryos, sheep embryos, canine embryos, feline embryos, fish embryos, and the like. A detection unit 106 may utilize numerous methods to determine the position of a non-human embryo that is being transported through a flow channel 120. For example, in some embodiments, a detection unit 106 may utilize imaging methods, spectroscopic methods, light scattering methods, and the like to determine the position of a non-human embryo that is being transported through a flow channel 120.

In some embodiments, operation 1320 includes determining an anterior-posterior orientation of at least one non-human embryo that is being transported through the at least one flow channel 120 (not shown). In some embodiments, a detection unit 106 may determine an anterior-posterior orientation of a non-human embryo that is being transported through a flow channel 120. For example, in some embodiments, a detection unit 106 may utilize microscopy to determine the anterior-posterior orientation of a non-human embryo that is being transported through a flow channel 120. In some embodiments, a detection unit 106 may utilize imaging methods to determine the anterior-posterior orientation of a non-human embryo that is being transported through a flow channel 120. Accordingly, a detection unit 106 may utilize numerous methods to determine the anterior-posterior orientation of a non-human embryo that is being transported through a flow channel 120.

In some embodiments, operation 1320 includes determining an orientation of at least one insect embryo that is being transported through the at least one flow channel 120 (not shown). In some embodiments, a detection unit 106 may determine an orientation of an insect embryo that is being transported through a flow channel 120. In some embodiments, a detection unit 106 may utilize microscopy to determine the orientation of an insect embryo that is being transported through a flow channel 120. In some embodiments, a detection unit 106 may utilize imaging methods to determine the orientation of an insect embryo that is being transported through a flow channel 120. Accordingly, a detection unit 106 may utilize numerous methods to determine the orientation of an insect embryo that is being transported through a flow channel 120. A detection unit 106 may determine an orientation of numerous types of insect embryos that being transported through a flow channel 120. Examples of such insect embryos include, but are not limited to, mosquito embryos, drosophila embryos, tick embryos, beetle embryos, bee embryos, and the like.

In some embodiments, operation 1320 includes determining an anterior-posterior orientation of at least one insect embryo that is being transported through the at least one flow channel 120 (not shown). In some embodiments, a detection unit 106 may determine an anterior-posterior orientation of an insect embryo that is being transported through a flow channel 120. In some embodiments, a detection unit 106 may utilize microscopy to determine an anterior-posterior orientation of an insect embryo that is being transported through a flow channel 120. In some embodiments, a detection unit 106 may utilize imaging methods to determine an anterior-posterior orientation of an insect embryo that is being transported through a flow channel 120. Accordingly, a detection unit 106 may utilize numerous methods to determine an anterior-posterior orientation of an insect embryo that is being transported through a flow channel 120. A detection unit 106 may determine an anterior-posterior orientation of numerous types of insect embryos that being transported through a flow channel 120. Examples of such insect embryos include, but are not limited to, mosquito embryos, drosophila embryos, tick embryos, beetle embryos, bee embryos, and the like.

In some embodiments, operation 1320 includes determining an orientation of at least one mosquito embryo that is being transported through the at least one flow channel 120 (not shown). In some embodiments, a detection unit 106 may determine an orientation of at least one mosquito embryo that is being transported through a one flow channel 120. In some embodiments, a detection unit 106 may utilize microscopy to determine an orientation of a mosquito embryo that is being transported through a flow channel 120. In some embodiments, a detection unit 106 may utilize imaging methods to determine an orientation of a mosquito embryo that is being transported through a flow channel 120. Accordingly, a detection unit 106 may utilize numerous methods to determine an orientation of a mosquito embryo that is being transported through a flow channel 120. A detection unit 106 may determine an orientation of numerous types of mosquito embryos. Examples of such mosquito embryos include, but are not limited to, those from Aedes aegypti, Anopheles stephensi, Ochlerotatus notoscriptus, Anopheles albimanus, and the like.

In some embodiments, operation 1320 includes determining an anterior-posterior orientation of at least one mosquito embryo that is being transported through the at least one flow channel 120 (not shown). In some embodiments, a detection unit 106 may determine an anterior-posterior orientation of a mosquito embryo that is being transported through a flow channel 120. In some embodiments, a detection unit 106 may determine the anterior-posterior orientation of a mosquito embryo by obtaining one or more images of a mosquito embryo in a flow channel 120 and then comparing the image of the mosquito embryo to a calibrated grid pattern in the flow channel 120. In some embodiments, a detection unit 106 may determine the anterior-posterior orientation of a mosquito embryo by obtaining one or more images of a mosquito embryo in a flow channel 120 and then comparing the image of the mosquito embryo to images included within a database. In some embodiments, a detection unit 106 may utilize microscopy to determine the anterior-posterior orientation of a mosquito embryo.

In some embodiments, operation 1320 includes determining longitudinal cross-sectional diameters to determine anterior-posterior orientation of at least one mosquito embryo that is being transported through the at least one flow channel 120 (not shown). In some embodiments, a detection unit 106 may determine longitudinal cross-sectional diameters to determine anterior-posterior orientation of a mosquito embryo that is being transported through a flow channel 120. For example, in some embodiments, a detection unit 106 may obtain one or more images of a mosquito embryo and then do pixel analysis of the image to determine cross-sectional diameters of the mosquito embryo at different positions along the length of the mosquito embryo. In some embodiments, a detection unit 106 may utilize one or more microscopes 168 to determine cross-sectional diameters of the mosquito embryo at different positions along the length of the mosquito embryo. In some embodiments, a detection unit 106 may obtain one or more images of a mosquito embryo within a flow channel 120 that includes a calibrated grid pattern to determine cross-sectional diameters of the mosquito embryo at different positions along the length of the mosquito embryo.

In some embodiments, operation 1320 includes determining segmental color to determine anterior-posterior orientation of at least one mosquito embryo that is being transported through the at least one flow channel 120 (not shown). In some embodiments, a detection unit 106 may determine segmental color to determine anterior-posterior orientation of a mosquito embryo that is being transported through a flow channel 120. In some embodiments, a detection unit 106 may obtain one or more images of a mosquito embryo and then do pixel analysis of the image to determine the color of segments along the length of the mosquito embryo. In some embodiments, a detection unit 106 may utilize spectroscopy to determine the color of segments along the length of the mosquito embryo.

In some embodiments, operation 1330 includes directing focused energy at a location adjacent to the at least one biological object to cause at least one cavitation induced perforation in the at least one biological object in the at least one flow channel 120 (not shown). In some embodiments, an emission unit 110 may direct focused energy at a location adjacent to a biological object to cause a cavitation induced perforation in the biological object in the flow channel 120. For example, in some embodiments, an emission unit 110 may direct focused energy to create a cavitation bubble that is adjacent to a biological object. The cavitation bubble may collapse asymmetrically due to the solid boundary of the biological object and create a jet flow that is directed into the biological object to perforate the biological object. In some embodiments, an emission unit 110 may direct laser light at a location that is adjacent to a biological object. In some embodiments, an emission unit 110 may direct focused microwave energy at a location that is adjacent to a biological object. In some embodiments, an emission unit 110 may direct focused radiofrequency energy at a location that is adjacent to a biological object. Accordingly, in some embodiments, an emission unit 110 may direct numerous types of focused energy to create a cavitation induced perforation in a biological object that is being transported through a flow channel 120.

In some embodiments, operation 1330 includes directing microwave energy to cause at least one cavitation induced perforation in the at least one biological object in the at least one flow channel 120 (not shown). In some embodiments, an emission unit 110 may direct focused microwave energy to cause a cavitation induced perforation in a biological object in a flow channel 120.

In some embodiments, operation 1330 includes directing radiofrequency energy to cause at least one cavitation induced perforation in the at least one biological object in the at least one flow channel 120 (not shown). In some embodiments, an emission unit 110 may direct focused radiofrequency energy to cause a cavitation induced perforation in a biological object in a flow channel 120.

In some embodiments, operation 1330 includes directing ultrasonic energy to cause at least one cavitation induced perforation in the at least one biological object in the at least one flow channel 120 (not shown). In some embodiments, an emission unit 110 may direct focused radiofrequency energy to cause a cavitation induced perforation in a biological object in a flow channel 120.

In some embodiments, operation 1330 includes directing light to cause at least one cavitation induced perforation in the at least one biological object in the at least one flow channel 120 (not shown). In some embodiments, an emission unit 110 may direct focused light to cause a cavitation induced perforation in a biological object in a flow channel 120. For example, in some embodiments, an emission unit 110 may direct light through one or more waveguides that are operably coupled to a flow channel 120 to cause a cavitation induced perforation in a biological object in the flow channel 120. In some embodiments, an emission unit 110 may direct light through one or more optical fibers that are operably coupled to a flow channel 120 to cause a cavitation induced perforation in a biological object in the flow channel 120. In some embodiments, an emission unit 110 may direct light emitted from a laser to cause a cavitation induced perforation in a biological object in a flow channel 120.

In some embodiments, operation 1330 includes directing at least one laser 220 to emit light to cause at least one cavitation induced perforation in the at least one biological object (not shown). In some embodiments, an emission unit 110 may direct laser light to cause a cavitation induced perforation in a biological object in a flow channel 120. In some embodiments, an emission unit 110 may direct a laser 220 to emit light directly into a flow channel 120 to cause a cavitation induced perforation in a biological object in the flow channel 120. For example, in some embodiments, an emission unit 110 may direct laser light directly onto a substrate 118 having a quartz layer such that the laser light passes through the quartz layer and causes a cavitation induced perforation in a biological object in a flow channel 120 within the substrate 118.

In some embodiments, operation 1330 includes directing at least one laser to emit light to cause at least one cavitation induced perforation in the at least one biological object in response to dynamically determining the position and orientation of the at least one biological object in the at least one flow channel 120 (not shown). In some embodiments, an emission unit 110 may direct a laser 220 to emit light to cause a cavitation induced perforation in a biological object in response to dynamically determining the position and orientation of a biological object in a flow channel 120. For example, in some embodiments, an emission unit 110 may receive one or more signals 108 that instruct the emission unit 110 to emit laser light into a flow channel 120 at one or more times and at one or more positions in the future where a biological object is predicted to be at the one or more times. In some embodiments, an emission unit 110 may receive one or more signals 108 that instruct the emission unit 110 to emit laser light into a flow channel 120 to cause at least one cavitation induced perforation in a biological object that is in motion.

In some embodiments, operation 1330 includes directing focused energy to cause at least one cavitation induced perforation in at least one bacterium, cell, human cell, non-human cell, plant cell, egg, avian egg, non-human embryo, non-human mammalian embryo, or insect embryo (not shown). In some embodiments, an emission unit 110 may direct focused energy to cause at least one cavitation induced perforation in at least one bacterium, cell, human cell, non-human cell, plant cell, egg, avian egg, non-human embryo, non-human mammalian embryo, or insect embryo.

In some embodiments, operation 1330 includes directing at least one laser 220 to emit light to cause at least one cavitation induced perforation in at least one mosquito embryo (not shown). In some embodiments, an emission unit 110 may direct a laser 220 to emit light to cause at least one cavitation induced perforation in a mosquito embryo. In some embodiments, an emission unit 110 may direct laser light to cause a cavitation induced perforation in a mosquito embryo in a flow channel 120. In some embodiments, an emission unit 110 may direct a laser 220 to emit light directly into a flow channel 120 to cause a cavitation induced perforation in a mosquito embryo in the flow channel 120. For example, in some embodiments, an emission unit 110 may direct laser light directly onto a substrate 118 having a quartz layer such that the laser light passes through the quartz layer and causes a cavitation induced perforation in a mosquito embryo in a flow channel 120 within the substrate 118.

In some embodiments, operation 1330 includes directing at least one laser 220 to emit light to cause at least one cavitation induced perforation in the at least one non-human embryo in response to dynamically determining the position and orientation of the at least one non-human embryo in the at least one flow channel 120 (not shown). In some embodiments, an emission unit 110 may direct a laser 220 to emit light to cause a cavitation induced perforation in a non-human embryo in response to dynamically determining the position and orientation of the non-human embryo in a flow channel 120. For example, in some embodiments, an emission unit 110 may receive one or more signals 108 that instruct the emission unit 110 to emit laser light into a flow channel 120 at one or more times and at one or more positions in the future where a non-human embryo is predicted to be at the one or more times. In some embodiments, an emission unit 110 may receive one or more signals 108 that instruct the emission unit 110 to emit laser light into a flow channel 120 to cause at least one cavitation induced perforation in a non-human embryo that is in motion. In some embodiments, an emission unit 110 may receive one or more signals 108 that instruct the emission unit 110 to emit laser light into a flow channel 120 at one or more times and at one or more positions in the future where a selected portion of a non-human embryo is predicted to be at the one or more times. In some embodiments, an emission unit 110 may receive one or more signals 108 that instruct the emission unit 110 to emit laser light into a flow channel 120 to cause at least one cavitation induced perforation in a selected portion of a non-human embryo that is in motion.

In some embodiments, operation 1330 includes directing at least one laser 220 to emit light to cause at least one cavitation induced perforation in at least one non-human embryo in response to dynamically determining the position and anterior-posterior orientation of the at least one non-human embryo in the at least one flow channel 120 (not shown). In some embodiments, an emission unit 110 may direct a laser 220 to emit light to cause a cavitation induced perforation in a non-human embryo in response to dynamically determining the position and anterior-posterior orientation of the non-human embryo in a flow channel 120. For example, in some embodiments, an emission unit 110 may receive one or more signals 108 that instruct the emission unit 110 to emit laser light into a flow channel 120 at one or more times and at one or more positions in the future where a non-human embryo is predicted to be at the one or more times. In some embodiments, an emission unit 110 may receive one or more signals 108 that instruct the emission unit 110 to emit laser light into a flow channel 120 to cause at least one cavitation induced perforation in a non-human embryo that is in motion. In some embodiments, an emission unit 110 may receive one or more signals 108 that instruct the emission unit 110 to emit laser light into a flow channel 120 at one or more times and at one or more positions in the future where an anterior portion of a non-human embryo is predicted to be at the one or more times. In some embodiments, an emission unit 110 may receive one or more signals 108 that instruct the emission unit 110 to emit laser light into a flow channel 120 at one or more times and at one or more positions in the future where a posterior portion of a non-human embryo is predicted to be at the one or more times. In some embodiments, an emission unit 110 may receive one or more signals 108 that instruct the emission unit 110 to emit laser light into a flow channel 120 to cause at least one cavitation induced perforation in an anterior portion of a non-human embryo that is in motion. In some embodiments, an emission unit 110 may receive one or more signals 108 that instruct the emission unit 110 to emit laser light into a flow channel 120 to cause at least one cavitation induced perforation in a posterior portion of a non-human embryo that is in motion.

In some embodiments, operation 1330 includes directing at least one laser 220 to emit light to cause at least one cavitation induced perforation in at least one insect embryo in response to dynamically determining the position and anterior-posterior orientation of the at least one insect embryo in the at least one flow channel 120 (not shown). In some embodiments, an emission unit 110 may direct a laser 220 to emit light to cause a cavitation induced perforation in an insect embryo in response to dynamically determining the position and anterior-posterior orientation of the insect embryo in a flow channel 120. For example, in some embodiments, an emission unit 110 may receive one or more signals 108 that instruct the emission unit 110 to emit laser light into a flow channel 120 at one or more times and at one or more positions in the future where an insect embryo is predicted to be at the one or more times. In some embodiments, an emission unit 110 may receive one or more signals 108 that instruct the emission unit 110 to emit laser light into a flow channel 120 to cause at least one cavitation induced perforation in an insect embryo that is in motion. In some embodiments, an emission unit 110 may receive one or more signals 108 that instruct the emission unit 110 to emit laser light into a flow channel 120 at one or more times and at one or more positions in the future where an anterior portion of an insect embryo is predicted to be at the one or more times. In some embodiments, an emission unit 110 may receive one or more signals 108 that instruct the emission unit 110 to emit laser light into a flow channel 120 at one or more times and at one or more positions in the future where a posterior portion of an insect embryo is predicted to be at the one or more times. In some embodiments, an emission unit 110 may receive one or more signals 108 that instruct the emission unit 110 to emit laser light into a flow channel 120 to cause at least one cavitation induced perforation in an anterior portion of an insect embryo that is in motion. In some embodiments, an emission unit 110 may receive one or more signals 108 that instruct the emission unit 110 to emit laser light into a flow channel 120 to cause at least one cavitation induced perforation in a posterior portion of an insect embryo that is in motion.

In some embodiments, operation 1330 includes directing at least one laser 220 to emit light to cause at least one cavitation induced perforation in at least one mosquito embryo in response to dynamically determining the position and anterior-posterior orientation of the at least one mosquito embryo in the at least one flow channel 120 (not shown). In some embodiments, an emission unit 110 may direct a laser 220 to emit light to cause a cavitation induced perforation in a mosquito embryo in response to dynamically determining the position and anterior-posterior orientation of the mosquito embryo in a flow channel 120. For example, in some embodiments, an emission unit 110 may receive one or more signals 108 that instruct the emission unit 110 to emit laser light into a flow channel 120 at one or more times and at one or more positions in the future where a mosquito embryo is predicted to be at the one or more times. In some embodiments, an emission unit 110 may receive one or more signals 108 that instruct the emission unit 110 to emit laser light into a flow channel 120 to cause at least one cavitation induced perforation in a mosquito embryo that is in motion. In some embodiments, an emission unit 110 may receive one or more signals 108 that instruct the emission unit 110 to emit laser light into a flow channel 120 at one or more times and at one or more positions in the future where an anterior portion of a mosquito embryo is predicted to be at the one or more times. In some embodiments, an emission unit 110 may receive one or more signals 108 that instruct the emission unit 110 to emit laser light into a flow channel 120 at one or more times and at one or more positions in the future where a posterior portion of a mosquito embryo is predicted to be at the one or more times. In some embodiments, an emission unit 110 may receive one or more signals 108 that instruct the emission unit 110 to emit laser light into a flow channel 120 to cause at least one cavitation induced perforation in an anterior portion of a mosquito embryo that is in motion. In some embodiments, an emission unit 110 may receive one or more signals 108 that instruct the emission unit 110 to emit laser light into a flow channel 120 to cause at least one cavitation induced perforation in a posterior portion of a mosquito embryo that is in motion.

In some embodiments, operation 1330 includes directing at least one laser 220 to emit light to cause at least one cavitation induced perforation in a posterior portion of at least one mosquito embryo in response to dynamically determining the position and anterior-posterior orientation of the at least one mosquito embryo in the at least one flow channel 120 (not shown). In some embodiments, an emission unit 110 may direct a laser 220 to emit light to cause a cavitation induced perforation in a posterior portion of a mosquito embryo in response to dynamically determining the position and anterior-posterior orientation of the mosquito embryo in a flow channel 120. In some embodiments, an emission unit 110 may receive one or more signals 108 that instruct the emission unit 110 to emit laser light into a flow channel 120 at one or more times and at one or more positions in the future where a posterior portion of a mosquito embryo is predicted to be at the one or more times. In some embodiments, an emission unit 110 may receive one or more signals 108 that instruct the emission unit 110 to emit laser light into a flow channel 120 to cause at least one cavitation induced perforation in a posterior portion of a mosquito embryo that is in motion.

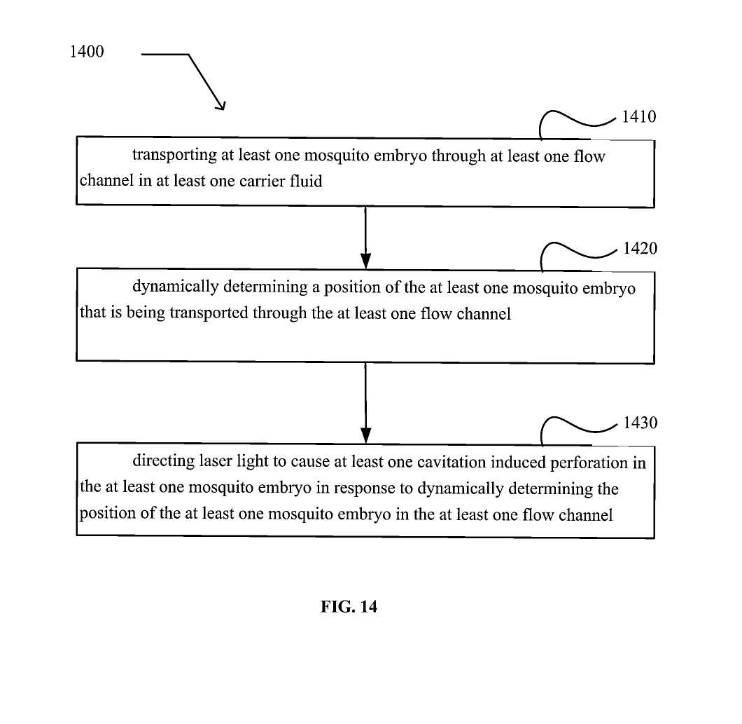

FIG. 14 illustrates operational flow 1400 that includes operation 1410 that includes transporting at least one mosquito embryo through at least one flow channel 120 in at least one carrier fluid, operation 1420 that includes dynamically determining a position of the at least one mosquito embryo that is being transported through the at least one flow channel 120, and operation 1430 that includes directing laser light to cause at least one cavitation induced perforation in the at least one mosquito embryo in response to dynamically determining the position of the at least one mosquito embryo in the at least one flow channel 120.

In FIG. 14 and in the following description that includes various examples of operations used during performance of the method, discussion and explanation may be provided with respect to any one or combination of the above-described examples, and/or with respect to other examples and contexts. However, it should be understood that the operations may be executed in a number of other environments and contexts, and/or modified versions of the figures. Also, although the various operations are presented in the sequence(s) illustrated, it should be understood that the various operations may be performed in other orders than those which are illustrated, or may be performed concurrently.

Operation 1410 includes transporting at least one mosquito embryo through at least one flow channel 120 in at least one carrier fluid. In some embodiments, a mosquito embryo may be transported through a flow channel 120 that is included within a flow unit 102. In some embodiments, a fluid control unit 104 may cause one or more carrier fluids to flow through the at least one flow channel 120. In some embodiments, a fluid control unit 104 may receive one or more signals 108 that control the operation of the fluid control unit 104. A mosquito embryo may be transported in numerous types of carrier fluids and combinations of carrier fluids. Examples of such carrier fluids include, but are not limited to, hydrophilic carrier fluids, aqueous carrier fluids, buffers, growth media, and the like. Numerous types of mosquito embryos may be transported through one or more flow channels 120. For example, mosquito embryos from Aedes aegypti, Anopheles stephensi, Ochlerotatus notoscriptus, Anopheles albimanus, and the like may be transported through a flow channel 120.

Operation 1420 includes dynamically determining a position of the at least one mosquito embryo that is being transported through the at least one flow channel 120. In some embodiments, one or more detection units 106 may dynamically determine a position of at least one mosquito embryo that is being transported through at least one flow channel 120. In some embodiments, a detection unit 106 may determine the position of at least one mosquito embryo that is being transported through at least one flow channel 120. In some embodiments, a detection unit 106 may determine the velocity of at least one mosquito embryo that is being transported through at least one flow channel 120. In some embodiments, a detection unit 106 may determine the position and velocity of at least one mosquito embryo that is being transported through at least one flow channel 120. In some embodiments, a detection unit 106 may predict one or more future positions of at least one mosquito embryo that is being transported through at least one flow channel 120 at one or more future times. In some embodiments, a detection unit 106 may continuously determine the position of at least one mosquito embryo that is being transported through at least one flow channel 120. In some embodiments, a detection unit 106 may continuously determine the velocity of at least one mosquito embryo that is being transported through at least one flow channel 120. In some embodiments, a detection unit 106 may continuously determine the position and velocity of at least one mosquito embryo that is being transported through at least one flow channel 120. In some embodiments, a detection unit 106 may intermittently determine the position of at least one mosquito embryo that is being transported through at least one flow channel 120. In some embodiments, a detection unit 106 may intermittently determine the velocity of at least one mosquito embryo that is being transported through at least one flow channel 120. In some embodiments, a detection unit 106 may intermittently determine the position and velocity of at least one mosquito embryo that is being transported through at least one flow channel 120. A detection unit 106 may be configured in numerous ways to dynamically determine a position of at least one mosquito embryo that is being transported through at least one flow channel 120. For example, in some embodiments, a detection unit 106 may be configured to acquire one or more images of a mosquito embryo that is being transported through a flow channel 120. In some embodiments, a detection unit 106 may dynamically determine a position of at least one mosquito embryo that is being transported through at least one flow channel 120 through the use of spectroscopy. In some embodiments, a detection unit 106 may dynamically determine a position of at least one mosquito embryo that is being transported through at least one flow channel 120 through detection of electrical conductance, resistance, and/or capacitance.

Operation 1430 includes directing laser light to cause at least one cavitation induced perforation in the at least one mosquito embryo in response to dynamically determining the position of the at least one mosquito embryo in the at least one flow channel 120. In some embodiments, one or more emission units 110 may direct laser light to cause at least one cavitation induced perforation in at least one mosquito embryo in response to dynamically determining the position of at least one mosquito embryo in at least one flow channel 120. In some embodiments, one or more emission units 110 may direct laser light at one or more mosquito embryos that are being transported through one or more flow channels 120 in one or more carrier fluids. For example, in some embodiments, an emission unit 110 may dynamically track the movement of a mosquito embryo as it is transported through a flow channel 120. Accordingly, in some embodiments, an emission unit 110 may track the movement of a mosquito embryo and direct laser light to cause at least one cavitation induced perforation in the mosquito embryo while it is moving. In some embodiments, an emission unit 110 may direct laser light at one or more positions in a flow channel 120 where a mosquito embryo is predicted to be at one or more times in the future. For example, in some embodiments, an emission unit 110 may direct a pulse of laser light at a position in an flow channel 120 at a time when a mosquito embryo is predicted to be at the position in the flow channel 120. Accordingly, in some embodiments, an emission unit 110 may direct laser light at a time and position in a flow channel 120 based on the predicted position of a mosquito embryo in the flow channel 120 at a time in the future. In some embodiments, an emission unit 110 may direct laser light to cause a cavitation induced perforation in the posterior pole of a mosquito embryo.

In some embodiments, operation 1410 includes transporting the at least one mosquito embryo through the at least one flow channel 120 in at least one buffer (not shown). In some embodiments, a mosquito embryo may be transported through a flow channel 120 in a flow unit 102 in at least one buffer. Numerous types of buffers may be used. Examples of such buffers include, but are not limited to, TAPS (3-{[tris(hydroxymethyl)methyl]amino}propanesulfonic acid), TRIS (tris(hydroxymethyl)methylamine), HEPES (4-2-hydroxyethyl-1-piperazineethanesulfonic acid), MOPS (3-(N-morpholino)propanesulfonic acid), and the like.

In some embodiments, operation 1410 includes transporting at least one mosquito embryo through the at least one flow channel 120 that has a width that is greater than the cross-sectional diameter of the at least one mosquito embryo and less than the length of the at least one mosquito embryo (not shown). In some embodiments, a mosquito embryo may be transported through a flow unit 102 that includes a flow channel 120 having a width and a depth that are greater than the cross-sectional diameter of the mosquito embryo and less than the length of the mosquito embryo. For example, in some embodiments, a mosquito embryo may be transported through a flow channel 120 having a width and a depth that are between about 0.4 millimeter and about 0.2 millimeter.

In some embodiments, operation 1410 includes transporting the at least one mosquito embryo through the at least one flow channel 120 that has a width that is between about 1 millimeter and about 0.1 millimeter (not shown). In some embodiments, a mosquito embryo may be transported through a flow unit 102 that includes a flow channel 120 having a width and a depth that are between about 1 millimeter and about 0.1 millimeter.

In some embodiments, operation 1410 includes transporting the at least one mosquito embryo through the at least one flow channel 120 that has a width that is between about 0.4 millimeter and about 0.2 millimeter (not shown). In some embodiments, a mosquito embryo may be transported through a flow unit 102 that includes a flow channel 120 having a width and a depth that are between about 0.4 millimeter and about 0.2 millimeter.

In some embodiments, operation 1410 includes transporting the at least one mosquito embryo through the at least one flow channel 120 that has a width that is about 0.3 millimeter (not shown). In some embodiments, a mosquito embryo may be transported through a flow unit 102 that includes a flow channel 120 having a width and a depth that are about 0.3 millimeter.

In some embodiments, operation 1410 includes actively positioning the at least one mosquito embryo within the at least one flow channel 120 by controlling flow of the at least one carrier fluid in the at least one flow channel 120 (not shown). In some embodiments, a mosquito embryo may be actively positioned within a flow channel 120 that is included within a flow unit 102. For example, in some embodiments, a mosquito embryo may be actively positioned within a flow channel 120 by controlling the operation of one or more pumps 148 that control flow of a carrier fluid through the flow channel 120. In some embodiments, a detection unit 106 may detect the position of a mosquito embryo in a flow channel 120 and then transmit one or more signals 108 that are received by a fluid control unit 104 that controls the operation of one or more pumps 148 in response to the one or more signals 108. In some embodiments, one or more fluid control units 104 may cause one or more pumps 148 to reverse the flow of one or more carrier fluids through a flow channel 120.

In some embodiments, operation 1410 includes actively positioning the at least one mosquito embryo within the at least one flow channel 120 by controlling flow of the at least one carrier fluid in the at least one flow channel 120 in response to dynamically determining the position of the at least one mosquito embryo (not shown). In some embodiments, a mosquito embryo may be actively positioned within a flow channel 120 that is included within a flow unit 102 in response to dynamically determining the position of the mosquito embryo in the flow channel 120. For example, in some embodiments, a detection unit 106 may determine the movement of a mosquito embryo being transported through a flow channel 120 and transmit one or more signals 108 that are received by a fluid control unit 104 that controls the operation of one or more pumps 148 in response to the one or more signals 108.

In some embodiments, operation 1410 includes transporting the at least one mosquito embryo in at least one carrier fluid that includes at least one article that can enter into the at least one mosquito embryo through the at least one cavitation induced perforation in the at least one mosquito embryo (not shown). In some embodiments, a carrier fluid may include an article that can enter into a mosquito embryo through a cavitation induced perforation. Numerous types of articles may be included in a carrier fluid. Examples of such articles include, but are not limited to, artificial nucleic acid constructs, bacteria, peptides, peptide constructs, polypeptides, antibodies, drugs, tags, antigens, and the like.

In some embodiments, operation 1410 includes transporting the at least one mosquito embryo in at least one carrier fluid that includes at least one artificial nucleic acid construct that can enter into the at least one mosquito embryo through the at least one cavitation induced perforation (not shown). In some embodiments, a carrier fluid may include an artificial nucleic acid construct that can enter into a mosquito embryo through a cavitation induced perforation. Numerous types of artificial nucleic acid constructs may be included in a carrier fluid. Examples of such artificial nucleic acid constructs include, but are not limited to, plasmids, artificial chromosomes, and the like. In some embodiments, artificial nucleic acid constructs may be constructed that will be expressed within a mosquito embryo that they enter. For example, in some embodiments, an artificial nucleic acid construct may encode one or more proteins that are expressed within a mosquito embryo. Examples of such proteins include, but are not limited to, marker proteins (e.g., green fluorescent protein), enzymes, antigens, and the like. In some embodiments, an artificial nucleic acid construct may encode a nucleic acid. Examples of such nucleic acids include, but are not limited to, an antisense message, a ribozyme, a transfer ribonucleic acid, and the like. In some embodiments, an artificial nucleic acid construct may include one or more transposable elements. Accordingly, in some embodiments, an artificial nucleic acid construct may be used to transform one or more mosquito embryos. In some embodiments, an artificial nucleic acid construct may be used to create a transgenic mosquito. In some embodiments, an artificial nucleic acid construct may be used for gene replacement in a mosquito. In some embodiments, an artificial nucleic acid construct may be used to create a knock-in mutation in a mosquito. In some embodiments, an artificial nucleic acid construct may be used to create a knock-out mutation in a mosquito. Accordingly, artificial nucleic acid constructs may be configured in numerous ways.

In some embodiments, operation 1410 includes transporting the at least one mosquito embryo in at least one carrier fluid that includes at least one artificial nucleic acid construct that encodes a marker that can enter into the at least one mosquito embryo through the at least one cavitation induced perforation (not shown). In some embodiments, a carrier fluid may include an artificial nucleic acid construct that encodes a marker that can enter into a mosquito embryo through a cavitation induced perforation. Artificial nucleic acid constructs may encode numerous types of markers that may be expressed within a mosquito embryo that they enter. In some embodiments, a marker may be a fluorescent protein. Examples of such fluorescent proteins include, but are not limited to, green fluorescent protein, red fluorescent protein, yellow fluorescent protein, and the like. In some embodiments, an artificial nucleic acid construct may encode a marker protein that inserts into a membrane of a mosquito embryo and serves to identify the mosquito embryo. In some embodiments, such marker proteins may be recognized by an antibody.

In some embodiments, operation 1410 includes transporting the at least one mosquito embryo in at least one carrier fluid that includes at least one artificial nucleic acid construct that includes a transposable element that can enter into the at least one mosquito embryo through the at least one cavitation induced perforation (not shown). In some embodiments, a carrier fluid may include an artificial nucleic acid construct that includes a transposable element that can enter into a mosquito embryo through a cavitation induced perforation. An artificial nucleic acid construct may include numerous types of transposable elements. Examples of such transposable elements include, but are not limited to, Hermes, Mariner, Minos, PiggyBac, P elements, SINE, and the like.

In some embodiments, operation 1410 includes transporting the at least one mosquito embryo in at least one carrier fluid that includes at least one artificial nucleic acid construct that includes at least one transposable element selected from Hermes, Mariner, Minos, or PiggyBac that can enter into the at least one mosquito embryo through the at least one cavitation induced perforation (not shown). In some embodiments, a carrier fluid may include an artificial nucleic acid construct that includes at least one transposable element selected from Hermes, Mariner, Minos, or PiggyBac that can enter into a mosquito embryo through a cavitation induced perforation.

In some embodiments, operation 1410 includes transporting the at least one mosquito embryo in at least one carrier fluid that includes at least one peptide construct that can enter into the at least one mosquito embryo through the at least one cavitation induced perforation (not shown). In some embodiments, a carrier fluid may include a peptide construct that can enter into a mosquito embryo through a cavitation induced perforation. Numerous types of peptide constructs may be included within a carrier fluid. Examples of such peptide constructs include, but are not limited to, antibodies, antigens, marker proteins, enzymes, and the like.

In some embodiments, operation 1410 includes transporting the at least one mosquito embryo in at least one carrier fluid that includes at least one microbe that can enter into the at least one mosquito embryo through the at least one cavitation induced perforation (not shown). In some embodiments, a carrier fluid may include a microbe that can enter into a mosquito embryo through a cavitation induced perforation. Numerous types of microbes may be included within a carrier fluid. Examples of such microbes include, but are not limited to, bacteria, protozoa, fungi, algae, and the like.

In some embodiments, operation 1410 includes transporting the at least one mosquito embryo in at least one carrier fluid that includes Wolbachia bacteria that can enter into the at least one mosquito embryo through the at least one cavitation induced perforation (not shown). In some embodiments, a carrier fluid may include Wolbachia bacteria that can enter into a mosquito embryo through a cavitation induced perforation.

In some embodiments, operation 1410 includes transporting the at least one mosquito embryo in at least one carrier fluid that includes at least one tag that can enter into the at least one mosquito embryo through the at least one cavitation induced perforation (not shown). In some embodiments, a carrier fluid may include a tag that can enter into a mosquito embryo through a cavitation induced perforation. Numerous types of tags may be included within a carrier fluid. Examples of such tags include, but are not limited to, dyes, quantum dots, ethidium bromide, fluorescein, rhodamine, cyanine, isotope tags, and the like.

In some embodiments, operation 1420 includes determining the velocity of the at least one mosquito embryo that is being transported through the at least one flow channel 120 (not shown). In some embodiments, a detection unit 106 may determine the velocity of a mosquito embryo that is being transported through a flow channel 120. For example, in some embodiments, a detection unit 106 may determine the position of a mosquito embryo in a flow channel 120 at a first time point and determine the position of the mosquito embryo at a second time point. The detection unit 106 may then calculate the velocity of the mosquito embryo by dividing the distance travelled by the time used to travel the distance.

In some embodiments, operation 1420 includes determining the position of the at least one mosquito embryo at a first time point and determining the position of the at least one mosquito embryo at another time point and calculating the velocity of the at least one mosquito embryo that is being transported through the at least one flow channel 120 (not shown). In some embodiments, a detection unit 106 may determine the position of a mosquito embryo at a first time point and determine the position of the mosquito embryo at another time point and then calculate the velocity of the mosquito embryo that is being transported through a flow channel 120. For example, the detection unit 106 may calculate the velocity of the mosquito embryo by dividing the distance travelled by the time used to travel the distance.

In some embodiments, operation 1420 includes predicting the position of the at least one mosquito embryo that is being transported through the at least one flow channel 120 at one or more times in the future (not shown). In some embodiments, a detection unit 106 may predict the position of a mosquito embryo that is being transported through a flow channel 120 at one or more times in the future. For example, in some embodiments, a detection unit 106 may determine the velocity of a mosquito embryo that is being transported through a flow channel 120 and then use the velocity to predict one or more positions of the mosquito embryo in the flow channel 120 at one or more times in the future.

In some embodiments, operation 1420 includes comparing the position of the at least one mosquito embryo to a position of at least one fiducial marker 122 associated with the at least one flow channel 120 (not shown). In some embodiments, a detection unit 106 may compare the position of a mosquito embryo within a flow channel 120 to a position of a fiducial marker 122 associated with the flow channel 120. For example, in some embodiments, one or more fiducial markers 122 may be associated with a flow channel 120 at known positions along the length of the flow channel 120. Accordingly, in some embodiments, a detection unit 106 may acquire an image of a mosquito embryo that is being transported through a flow channel 120 that is associated with one or more fiducial markers 122 and then compare the position of the mosquito embryo to the fiducial markers 122 in the image.

In some embodiments, operation 1420 includes determining the position of the at least one mosquito embryo in the at least one flow channel 120 through optical detection (not shown). In some embodiments, a detection unit 106 may determine the position of a mosquito embryo in a flow channel 120 through use of optical detection. A detection unit 106 may utilize numerous optical detection methods to detect a mosquito embryo in a flow channel 120. Examples of such optical detection methods include, but are not limited to, microscopy, spectroscopy, photography, and the like.

In some embodiments, operation 1420 includes determining the position of the at least one mosquito embryo in the at least one flow channel 120 through spectroscopic detection (not shown). In some embodiments, a detection unit 106 may determine the position of a mosquito embryo in a flow channel 120 through use of spectroscopic detection. A detection unit 106 may utilize numerous spectroscopic detection methods to detect a mosquito embryo in a flow channel 120. Examples of such spectroscopic detection methods include, but are not limited to, circular dichroism spectroscopy, ultraviolet/visible light spectroscopy, infrared spectroscopy, fluorescence spectroscopy, and the like.

In some embodiments, operation 1420 includes determining the position of the at least one mosquito embryo in the at least one flow channel 120 through fluorescence spectroscopy (not shown). In some embodiments, a detection unit 106 may determine the position of a mosquito embryo in a flow channel 120 through use of fluorescence spectroscopy. For example, in some embodiments, a detection unit 106 may detect intrinsic protein fluorescence of a mosquito embryo to determine the position of the mosquito embryo in a flow channel 120. In some embodiments, a detection unit 106 may detect a fluorescent tag that is associated with a mosquito embryo to determine the position of the mosquito embryo in a flow channel 120. For example, in some embodiments, a detection unit 106 may detect a quantum dot that is associated with a mosquito embryo. In some embodiments, a detection unit 106 may detect a fluorescent marker that is associated with a mosquito embryo to determine the position of the mosquito embryo in a flow channel 120. For example, in some embodiments, a detection unit 106 may detect the expression of green fluorescent protein by a mosquito embryo.

In some embodiments, operation 1420 includes imaging the at least one mosquito embryo in the at least one flow channel 120 (not shown). In some embodiments, a detection unit 106 may image a mosquito embryo in a flow channel 120. For example, in some embodiments, a detection unit 106 may utilize one or more microscopes 168 to obtain one or more images of a mosquito embryo that is being transported through a flow channel 120. In some embodiments, a detection unit 106 may utilize one or more cameras 170 to obtain one or more images of a mosquito embryo that is being transported through a flow channel 120. In some embodiments, a detection unit 106 may utilize one or more charge coupled devices to obtain one or more images of a mosquito embryo that is being transported through a flow channel 120.

In some embodiments, operation 1420 includes modeling the at least one mosquito embryo in the at least one flow channel 120 (not shown). In some embodiments, a detection unit 106 may model a mosquito embryo in a flow channel 120. For example, in some embodiments, a detection unit 106 may obtain multiple images of a mosquito embryo that is being transported through a flow channel 120 and then assemble the images into a three-dimensional model

In some embodiments, operation 1420 includes determining an orientation of at least one mosquito embryo that is being transported through the at least one flow channel 120 (not shown). In some embodiments, a detection unit 106 may determine an orientation of a mosquito embryo that is being transported through a flow channel 120. A detection unit 106 may utilize numerous methods to determine the orientation of a mosquito embryo being transported through a flow channel 120. For example, in some embodiments, a detection unit 106 may obtain one or more images of a mosquito embryo that is being transported through a flow channel 120 having a calibrated grid pattern in the flow channel 120. Accordingly, a detection unit 106 may utilize the calibrated grid pattern to determine the cross-sectional diameters of each of the poles of the mosquito embryo and then identify the anterior pole as having the greater cross-sectional diameter.

In some embodiments, operation 1420 includes processing at least one image of the at least one mosquito embryo to determine an orientation of the at least one mosquito embryo in the at least one flow channel 120 (not shown). In some embodiments, a detection unit 106 may process at least one image of a mosquito embryo to determine an orientation of the mosquito embryo in a flow channel 120. In some embodiments, a detection unit 106 may obtain an image of a mosquito embryo and then perform pixel analysis to determine the orientation of a mosquito embryo in a flow channel 120. For example, in some embodiments, an image of a mosquito embryo may be obtained and then processed to determine if the mosquito embryo is being transported through a flow channel 120 with the anterior pole of the mosquito embryo in front or with the posterior pole of the mosquito embryo in front. In some embodiments, the posterior pole of the mosquito embryo will have a smaller cross-sectional diameter than the anterior pole of the mosquito embryo.

In some embodiments, operation 1420 includes processing data associated with at least one detectable characteristic of the at least one mosquito embryo to determine an orientation of the at least one mosquito embryo in the at least one flow channel 120 (not shown). In some embodiments, a detection unit 106 may process data associated with at least one detectable characteristic of a mosquito embryo to determine an orientation of the mosquito embryo in the flow channel 120. In some embodiments, a detection unit 106 may obtain an image of a mosquito embryo and then perform pixel analysis to identify the anterior pole and the posterior pole of the mosquito embryo. In some embodiments, the posterior pole of the mosquito embryo will be darker in color than the anterior pole of the mosquito embryo. In some embodiments, a detection unit 106 may utilize spectroscopy to determine the orientation of a mosquito embryo in a flow channel 120. For example, in some embodiments, a detection unit 106 may utilize spectroscopy to determine which pole of a mosquito embryo is darker and thereby determine the posterior pole of the mosquito embryo

In some embodiments, operation 1420 includes determining an anterior-posterior orientation of at least one mosquito embryo that is being transported through the at least one flow channel 120 (not shown). In some embodiments, a detection unit 106 may determine an anterior-posterior orientation of a mosquito embryo that is being transported through a flow channel 120. In some embodiments, a detection unit 106 may determine the anterior-posterior orientation of a mosquito embryo by obtaining one or more images of a mosquito embryo in a flow channel 120 and then comparing the image of the mosquito embryo to a calibrated grid pattern in the flow channel 120. In some embodiments, a detection unit 106 may determine the anterior-posterior orientation of a mosquito embryo by obtaining one or more images of a mosquito embryo in a flow channel 120 and then comparing the image of the mosquito embryo to images included within a database. In some embodiments, a detection unit 106 may utilize microscopy to determine the anterior-posterior orientation of a mosquito embryo.

In some embodiments, operation 1420 includes determining longitudinal cross-sectional diameters to determine anterior-posterior orientation of at least one mosquito embryo that is being transported through the at least one flow channel 120 (not shown). In some embodiments, a detection unit 106 may determine longitudinal cross-sectional diameters to determine anterior-posterior orientation of a mosquito embryo that is being transported through a flow channel 120. For example, in some embodiments, a detection unit 106 may obtain one or more images of a mosquito embryo and then do pixel analysis of the image to determine cross-sectional diameters of the mosquito embryo at different positions along the length of the mosquito embryo. In some embodiments, a detection unit 106 may utilize one or more microscopes 168 to determine cross-sectional diameters of the mosquito embryo at different positions along the length of the mosquito embryo. In some embodiments, a detection unit 106 may obtain one or more images of a mosquito embryo within a flow channel 120 that includes a calibrated grid pattern to determine cross-sectional diameters of the mosquito embryo at different positions along the length of the mosquito embryo

In some embodiments, operation 1420 includes determining segmental color to determine anterior-posterior orientation of at least one mosquito embryo that is being transported through the at least one flow channel 120 (not shown). In some embodiments, a detection unit 106 may determine segmental color to determine anterior-posterior orientation of a mosquito embryo that is being transported through a flow channel 120. In some embodiments, a detection unit 106 may obtain one or more images of a mosquito embryo and then do pixel analysis of the image to determine the color of segments along the length of the mosquito embryo. In some embodiments, a detection unit 106 may utilize spectroscopy to determine the color of segments along the length of the mosquito embryo.

In some embodiments, operation 1430 includes directing at least one laser 220 to emit light to cause at least one cavitation induced perforation in at least one mosquito embryo in response to dynamically determining the position and anterior-posterior orientation of the at least one mosquito embryo in the at least one flow channel 120 (not shown). In some embodiments, an emission unit 110 may direct a laser 220 to emit light to cause a cavitation induced perforation in a mosquito embryo in response to dynamically determining the position and anterior-posterior orientation of the mosquito embryo in a flow channel 120. For example, in some embodiments, an emission unit 110 may receive one or more signals 108 that instruct the emission unit 110 to emit laser light into a flow channel 120 at one or more times and at one or more positions in the future where a mosquito embryo is predicted to be at the one or more times. In some embodiments, an emission unit 110 may receive one or more signals 108 that instruct the emission unit 110 to emit laser light into a flow channel 120 to cause at least one cavitation induced perforation in a mosquito embryo that is in motion. In some embodiments, an emission unit 110 may receive one or more signals 108 that instruct the emission unit 110 to emit laser light into a flow channel 120 at one or more times and at one or more positions in the future where an anterior portion of a mosquito embryo is predicted to be at the one or more times. In some embodiments, an emission unit 110 may receive one or more signals 108 that instruct the emission unit 110 to emit laser light into a flow channel 120 at one or more times and at one or more positions in the future where a posterior portion of a mosquito embryo is predicted to be at the one or more times. In some embodiments, an emission unit 110 may receive one or more signals 108 that instruct the emission unit 110 to emit laser light into a flow channel 120 to cause at least one cavitation induced perforation in an anterior portion of a mosquito embryo that is in motion. In some embodiments, an emission unit 110 may receive one or more signals 108 that instruct the emission unit 110 to emit laser light into a flow channel 120 to cause at least one cavitation induced perforation in a posterior portion of a mosquito embryo that is in motion.

In some embodiments, operation 1430 includes directing at least one laser 220 to emit light to cause at least one cavitation induced perforation in a posterior portion of at least one mosquito embryo in response to dynamically determining the position and anterior-posterior orientation of the at least one mosquito embryo in the at least one flow channel 120 (not shown). In some embodiments, an emission unit 110 may direct a laser 220 to emit light to cause a cavitation induced perforation in a posterior portion of a mosquito embryo in response to dynamically determining the position and anterior-posterior orientation of the mosquito embryo in a flow channel 120. In some embodiments, an emission unit 110 may receive one or more signals 108 that instruct the emission unit 110 to emit laser light into a flow channel 120 at one or more times and at one or more positions in the future where a posterior portion of a mosquito embryo is predicted to be at the one or more times. In some embodiments, an emission unit 110 may receive one or more signals 108 that instruct the emission unit 110 to emit laser light into a flow channel 120 to cause at least one cavitation induced perforation in a posterior portion of a mosquito embryo that is in motion.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces 114, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Although user 116 is described herein as a single individual, those skilled in the art will appreciate that user 116 may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

All publications, patents and patent applications cited herein are incorporated herein by reference. The foregoing specification has been described in relation to certain embodiments thereof, and many details have been set forth for purposes of illustration, however, it will be apparent to those skilled in the art that the invention is susceptible to additional embodiments and that certain of the details described herein may be varied considerably without departing from the basic principles of the invention.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system comprising:
circuitry configured to control transport of at least one biological object through at least one flow channel in at least one carrier fluid;
circuitry configured to dynamically determine a position of the at least one biological object that is being transported through the at least one flow channel; and
circuitry configured to direct focused energy to cause at least one cavitation induced perforation in the at least one biological object in response to the circuitry configured to dynamically determine the position of the at least one biological object in the at least one flow channel.

2. The system of claim 1, wherein the circuitry configured to control transport of at least one biological object through at least one flow channel in at least one carrier fluid comprises:
circuitry configured to control at least one pump.

3-8. (canceled)

9. The system of claim 1, wherein the circuitry configured to control transport of at least one biological object through at least one flow channel in at least one carrier fluid comprises:
circuitry configured to control at least one pump in response to the circuitry configured to dynamically determine a position of the at least one biological object that is being transported through the at least one flow channel.

10. The system of claim 1, wherein the circuitry configured to dynamically determine a position of the at least one biological object that is being transported through the at least one flow channel comprises:
circuitry configured to determine the velocity of the at least one biological object that is being transported through the at least one flow channel.

11. (canceled)

12. The system of claim 1, wherein the circuitry configured to dynamically determine a position of the at least one biological object that is being transported through the at least one flow channel comprises:
circuitry configured to predict the position of the at least one biological object that is being transported through the at least one flow channel at one or more times in the future.

13. The system of claim 1, wherein the circuitry configured to dynamically determine a position of the at least one biological object that is being transported through the at least one flow channel comprises:
circuitry configured to compare the position of the at least one biological object to a position of at least one fiducial marker associated with the at least one flow channel.

14. The system of claim 1, wherein the circuitry configured to dynamically determine a position of the at least one biological object that is being transported through the at least one flow channel comprises:
circuitry configured to control at least one optical detector.

15-21. (canceled)

22. The system of claim 1, wherein the circuitry configured to dynamically determine a position of the at least one biological object that is being transported through the at least one flow channel comprises:
circuitry configured to process image data associated with the at least one biological object.

23. The system of claim 1, wherein the circuitry configured to dynamically determine a position of the at least one biological object that is being transported through the at least one flow channel comprises:
circuitry configured to process data associated with at least one detectable characteristic of the at least one biological object to determine an orientation of the at least one biological object in the at least one flow channel.

24. (canceled)

25. The system of claim 1, wherein the circuitry configured to dynamically determine a position of the at least one biological object that is being transported through the at least one flow channel comprises:
circuitry configured to process image data associated with at least one mosquito embryo.

26. The system of claim 1, wherein the circuitry configured to dynamically determine a position of the at least one biological object that is being transported through the at least one flow channel comprises:
circuitry configured to process image data associated with at least one mosquito embryo to determine an anterior-posterior orientation of the mosquito embryo.

27. The system of claim 1, wherein the circuitry configured to dynamically determine a position of the at least one biological object that is being transported through the at least one flow channel comprises:
circuitry configured to process image data associated with longitudinal cross-sectional diameters of at least one mosquito embryo to determine an anterior-posterior orientation of the mosquito embryo.

28. The system of claim 1, wherein the circuitry configured to dynamically determine a position of the at least one biological object that is being transported through the at least one flow channel comprises:
circuitry configured to process image data associated with segmental color of at least one mosquito embryo to determine an anterior-posterior orientation of the mosquito embryo.

29. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct focused energy at a location adjacent to the at least one biological object to cause at least one cavitation induced perforation in the at least one biological object.

30-32. (canceled)

33. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct light to cause at least one cavitation induced perforation in the at least one biological object in the at least one flow channel.

34. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct at least one laser to emit light that causes at least one cavitation induced perforation in the at least one biological object.

35. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct focused energy that causes at least one cavitation induced perforation in the at least one biological object in response to dynamically determining the position and orientation of the at least one biological object in the at least one flow channel.

36. (canceled)

37. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct at least one laser to emit light that causes at least one cavitation induced perforation in at least one mosquito embryo.

38. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct at least one laser to emit light that causes at least one cavitation induced perforation in the at least one non-human embryo in response to dynamically determining the position and orientation of the at least one non-human embryo in the at least one flow channel.

39. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct at least one laser to emit light that causes at least one cavitation induced perforation in at least one non-human embryo in response to dynamically determining the position and anterior-posterior orientation of the at least one non-human embryo in the at least one flow channel.

40. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct at least one laser to emit light that causes at least one cavitation induced perforation in at least one insect embryo in response to dynamically determining the position and anterior-posterior orientation of the at least one insect embryo in the at least one flow channel.

41. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct at least one laser to emit light that causes at least one cavitation induced perforation in at least one mosquito embryo in response to dynamically determining the position and anterior-posterior orientation of the at least one mosquito embryo in the at least one flow channel.

42. The system of claim 1, wherein the circuitry configured to direct focused energy to cause at least one cavitation induced perforation in the at least one biological object in response to the circuitry configured to dynamically determine the position of the at least one biological object in the at least one flow channel comprises:
circuitry configured to direct at least one laser to emit light that causes at least one cavitation induced perforation in a posterior portion of at least one mosquito embryo in response to dynamically determining the position and anterior-posterior orientation of the at least one mosquito embryo in the at least one flow channel.

43. A system comprising:
means for transporting at least one biological object through at least one flow channel in at least one carrier fluid;
means for dynamically determining a position of the at least one biological object that is being transported through the at least one flow channel; and
means for directing focused energy to cause at least one cavitation induced perforation in the at least one biological object in response to dynamically determining the position of the at least one biological object in the at least one flow channel.

44. A computer program product comprising:
at least one non-transitory computer readable media including at least:
one or more instructions to control transport of at least one biological object through at least one flow channel in at least one carrier fluid;
one or more instructions to dynamically determine a position of the at least one biological object that is being transported through the at least one flow channel; and
one or more instructions to direct focused energy to cause at least one cavitation induced perforation in the at least one biological object in response to dynamically determining the position of the at least one biological object in the at least one flow channel.

45. The computer program product of claim 44, wherein the at least one non-transitory computer readable media includes a recordable medium.

46. The computer program product of claim 44, wherein the at least one non-transitory computer readable media includes a communications medium.

47. A method comprising:
transporting at least one biological object through at least one flow channel in at least one carrier fluid;
dynamically determining a position of the at least one biological object that is being transported through the at least one flow channel; and
directing focused energy to cause at least one cavitation induced perforation in the at least one biological object in response to dynamically determining the position of the at least one biological object in the at least one flow channel.

48-168. (canceled)
